(19) United States
(12) Patent Application Publication
(10) Pub. No.: US 2024/0176993 A1
(43) Pub. Date: May 30, 2024

(54) Scalable Self-Supervised Graph Clustering

(71) Applicant: Google LLC, Mountain View, CA (US)

(72) Inventors: Prateek Jain, Bangalore (IN); Inderjit Singh Dhillon, Berkeley, CA (US); Fnu Devvrit, Austin, TX (US); Aditya Sinha, Champaign, IL (US)

(21) Appl. No.: 18/485,457

(22) Filed: Oct. 12, 2023

(30) Foreign Application Priority Data
Oct. 12, 2022 (IN) 202221058114

(51) Int. Cl. G06N 3/0464; G06N 3/0895

(52) U.S. Cl. CPC G06N 3/0464; G06N 3/0895

(57) ABSTRACT

A method of training a machine learning model includes receiving training data comprising a graph structure and one or more feature attributes and determining an encoded graph based on applying the machine learning model to the graph structure and the one or more feature attributes. The machine learning model comprises a graph convolutional network layer. The encoded graph comprises one or more nodes and one or more paths connecting the one or more nodes. The method also includes selecting a plurality of positive samples through random walks along the one or more paths of the encoded graph, selecting a plurality of negative samples from the encoded graph by randomly sampling the one or more nodes of the encoded graph, determining a loss value, and updating, based on the loss value, one or more learnable parameter values of the machine learning model.

### CROSS-REFERENCE TO RELATED APPLICATIONS

This application claims priority to Indian Provisional Patent Application No. 202221058114 filed Oct. 12, 2022, the disclosure of which is incorporated by reference herein in its entirety.

### BACKGROUND

Machine learning models may be used to process various types of data, including images, video, time series, text, and/or point clouds, among other possibilities. Improvements in the machine learning models and/or the training processes thereof may allow the models to carry out the processing of data faster and/or utilize fewer computing resources for the processing, among other benefits.

### SUMMARY

In an embodiment, a method of training a machine learning model includes receiving training data for the machine learning model, wherein the training data comprises a graph structure and one or more feature attributes. The method also includes determining an encoded graph based on applying the machine learning model to the graph structure and the one or more feature attributes. The machine learning model comprises a graph convolutional network layer, wherein the encoded graph comprises one or more nodes and one or more paths connecting the one or more nodes. The method additionally includes selecting a plurality of positive samples through random walks along the one or more paths of the encoded graph. The method further includes selecting a plurality of negative samples from the encoded graph by randomly sampling the one or more nodes of the encoded graph. The method additionally includes determining, based on applying a contrastive loss function to the plurality of positive samples and to the plurality of negative samples, a loss value. The method also includes updating, based on the loss value, one or more learnable parameter values of the machine learning model.

In another embodiment, a system includes a processor and a non-transitory computer-readable medium having stored thereon instructions that, when executed by the processor, cause the processor to perform operations of training a machine learning model. The operations include receiving training data for the machine learning model. The training data comprises a graph structure and one or more feature attributes. The operations also include determining an encoded graph based on applying the machine learning model to the graph structure and the one or more feature attributes, wherein the machine learning model comprises a graph convolutional network layer. The encoded graph comprises one or more nodes and one or more paths connecting the one or more nodes. The operations additionally include selecting a plurality of positive samples through random walks along the one or more paths of the encoded graph. The operations further include selecting a plurality of negative samples from the encoded graph by randomly sampling the one or more nodes of the encoded graph. The operations also include determining, based on applying a contrastive loss function to the plurality of positive samples and to the plurality of negative samples, a loss value. The operations further include updating, based on the loss value, one or more learnable parameter values of the machine learning model.

In another embodiment, a non-transitory computer readable medium is provided which includes program instructions executable by at least one processor to cause the at least one processor to perform functions of training a machine learning model. The functions include receiving training data for the machine learning model. The training data comprises a graph structure and one or more feature attributes. The functions also include determining an encoded graph based on applying the machine learning model to the graph structure and the one or more feature attributes, wherein the machine learning model comprises a graph convolutional network layer. The encoded graph comprises one or more nodes and one or more paths connecting the one or more nodes. The functions additionally include selecting a plurality of positive samples through random walks along the one or more paths of the encoded graph. The functions further include selecting a plurality of negative samples from the encoded graph by randomly sampling the one or more nodes of the encoded graph. The functions also include determining, based on applying a contrastive loss function to the plurality of positive samples and to the plurality of negative samples, a loss value. The functions further include updating, based on the loss value, one or more learnable parameter values of the machine learning model.

In a further embodiment, a system is provided that includes means for training a machine learning model. The system includes means for receiving training data for the machine learning model. The training data comprises a graph structure and one or more feature attributes. The system also includes means for determining an encoded graph based on applying the machine learning model to the graph structure and the one or more feature attributes, wherein the machine learning model comprises a graph convolutional network layer, wherein the encoded graph comprises one or more nodes and one or more paths connecting the one or more nodes. The system further includes means for selecting a plurality of positive samples through random walks along the one or more paths of the encoded graph. The system additionally includes means for selecting a plurality of negative samples from the encoded graph by randomly sampling the one or more nodes of the encoded graph. The system also includes means for determining, based on applying a contrastive loss function to the plurality of positive samples and to the plurality of negative samples, a loss value. The system further includes means for updating, based on the loss value, one or more learnable parameter values of the machine learning model.

In an additional embodiment, a method of applying a machine learning model is provided. The method includes determining an encoded graph output by applying a trained machine learning model to a graph structure input and one or more feature attribute inputs. The trained machine learning model comprises a graph convolutional network layer. The machine learning model outputs an encoded graph based on one or more learnable parameters values of the graph convolutional network layer. The one or more learnable parameters values of a graph convolutional network layer of the trained machine learning model were determined by applying a contrastive loss function to a plurality of positive samples selected through random walks along one or more paths of an encoded graph and a plurality of negative samples selected from the encoded graph by randomly sampling one or more nodes of the encoded graph. The method further includes applying a clustering algorithm to the encoded graph output to determine one or more graph clusters, wherein each graph cluster comprises one or more nearby nodes of the graph structure input with similar feature attributes.

In another embodiment, a system includes a processor and a non-transitory computer-readable medium having stored thereon instructions that, when executed by the processor, cause the processor to perform operations of applying a machine learning model. The operations include determining an encoded graph output by applying a trained machine learning model to a graph structure input and one or more feature attribute inputs. The trained machine learning model comprises a graph convolutional network layer. The machine learning model outputs an encoded graph based on one or more learnable parameters values of the graph convolutional network layer. The one or more learnable parameters values of a graph convolutional network layer of the trained machine learning model were determined by applying a contrastive loss function to a plurality of positive samples selected through random walks along one or more paths of an encoded graph and a plurality of negative samples selected from the encoded graph by randomly sampling one or more nodes of the encoded graph. The operations further include applying a clustering algorithm to the encoded graph output to determine one or more graph clusters, wherein each graph cluster comprises one or more nearby nodes of the graph structure input with similar feature attributes.

In another embodiment, a non-transitory computer-readable medium is provided which includes program instructions executable by at least one processor to cause the at least one processor to perform functions of applying a machine learning model. The functions include determining an encoded graph output by applying a trained machine learning model to a graph structure input and one or more feature attribute inputs. The trained machine learning model comprises a graph convolutional network layer. The machine learning model outputs an encoded graph based on one or more learnable parameters values of the graph convolutional network layer. The one or more learnable parameters values of a graph convolutional network layer of the trained machine learning model were determined by applying a contrastive loss function to a plurality of positive samples selected through random walks along one or more paths of an encoded graph and a plurality of negative samples selected from the encoded graph by randomly sampling one or more nodes of the encoded graph. The functions further include applying a clustering algorithm to the encoded graph output to determine one or more graph clusters, wherein each graph cluster comprises one or more nearby nodes of the graph structure input with similar feature attributes.

In another embodiment, a system is provided that includes means for applying a machine learning model. The system includes means for determining an encoded graph output by applying a trained machine learning model to a graph structure input and one or more feature attribute inputs. The trained machine learning model comprises a graph convolutional network layer. The machine learning model outputs an encoded graph based on one or more learnable parameters values of the graph convolutional network layer. The one or more learnable parameters values of a graph convolutional network layer of the trained machine learning model were determined by applying a contrastive loss function to a plurality of positive samples selected through random walks along one or more paths of an encoded graph and a plurality of negative samples selected from the encoded graph by randomly sampling one or more nodes of the encoded graph. The system also includes means for applying a clustering algorithm to the encoded graph output to determine one or more graph clusters, wherein each graph cluster comprises one or more nearby nodes of the graph structure input with similar feature attributes.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 is a diagram illustrating training and inference phases of a machine learning model, in accordance with example embodiments.

FIG. 2 depicts a distributed computing architecture, in accordance with example embodiments.

FIG. 3 is a block diagram of a computing device, in accordance with example embodiments.

FIG. 4 depicts a network of computing clusters arranged as a cloud-based server system, in accordance with example embodiments.

FIG. 4 is a flowchart of a method, in accordance with example embodiments.

FIG. 5 is a flowchart of a method, in accordance with example embodiments.

FIG. 7 is a visualization of embeddings, in accordance with example embodiments.

FIG. 8 depicts an algorithm, in accordance with example embodiments.

FIG. 9 depicts a table of results, in accordance with example embodiments.

FIG. 10 depicts statistics, in accordance with example embodiments.

FIG. 11a depicts a comparison between different clustering methods, in accordance with example embodiments.

FIG. 11b depicts comparison of embeddings generated between different clustering methods, in accordance with example embodiments.

FIG. 12 depicts an overview of the S³GC method, in accordance with example embodiments.

FIG. 13 depicts time and space complexities, in accordance with example embodiments.

FIG. 14 depicts a table with URLs, in accordance with example embodiments.

FIG. 15 depicts a visualization of embeddings, in accordance with example embodiments.

FIG. 16 depicts a visualization of embeddings, in accordance with example embodiments.

FIG. 17 depicts the effect of using different walk lengths, in accordance with example embodiments.

FIG. 18 depicts comparisons of different methods, in accordance with example embodiments.

FIG. 19a depicts comparisons of different methods, in accordance with example embodiments.

FIG. 19b depicts additional comparisons of different methods, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Graphs are data structures that can store information about entities, users, among other examples. In some examples, the entities and nodes may be equipped with vector embeddings from various sources. For example, nodes in a graph may represent authors, and each node (e.g., each author) may have associated feature attributes (e.g., title, content, etc. of the papers that the author wrote).

A computing system may cluster graphs in order to determine relationships between nodes and attributes. Clustering graph data may be useful for a variety of applications, including recommending, routing, triaging, among other examples. Methods for graph clustering may be most efficient when the clustering algorithm is scalable. In particular, an effective graph clustering algorithm may be able to cluster a graph with many nodes without exponentially increasing the amount of time or resources used.

With respect to clustering graphs with attributes, a few difficulties may arise, including combining the two views of the input data (e.g., a graph view and a feature view) into one view, managing time and memory so that the computing system does not run out of resources for large-scale datasets, among other examples. Provided herein are scalable methods to cluster graphs with attributes, such that a computing system may cluster large-scale graphs without running out of memory.

A graph structure may include one or more nodes, where a node has one or more associated feature attributes. During training, a computing system may apply a graph convolutional network layer to the training data to obtain an encoded graph. The encoded graph may include one or more encoded nodes and one or more encoded paths. The computing system may select positive samples through a random walk along one or more encoded paths. In addition, the computing system may select negative samples through random sampling of the one or more encoded nodes in the encoded graph. Based on applying a contrastive loss function to the positive samples and to the negative samples, the computing system may update learnable parameter values of the machine learning model.

After training the machine learning model, the computing system or some other computing system may apply the machine learning model. The computing system may input a graph with one or more feature attributes into the trained machine learning model to obtain an encoded graph. Subsequently, the computing system may apply a clustering algorithm (e.g., k-means clustering, among other examples) to the encoded graph to obtain one or more graph clusters, where each graph cluster includes one or more nearby nodes and/or one or more nodes with similar attributes.

### II. Example Systems and Methods

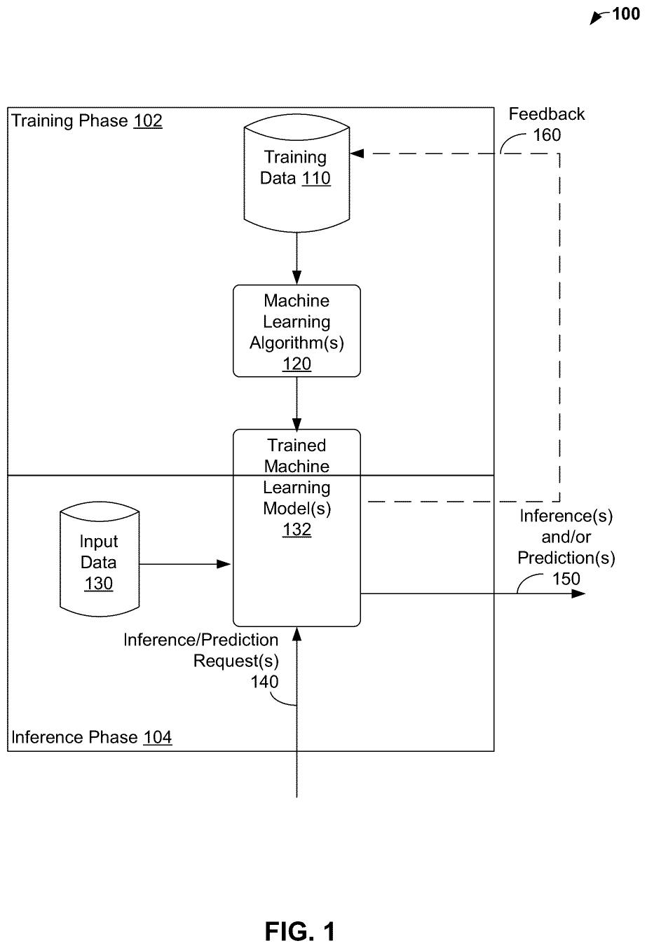

FIG. 1 shows diagram 100 illustrating a training phase 102 and an inference phase 104 of trained machine learning model(s) 132, in accordance with example embodiments. Some machine learning techniques involve training one or more machine learning algorithms, on an input set of training data to recognize patterns in the training data and provide output inferences and/or predictions about (patterns in the) training data. The resulting trained machine learning algorithm can be termed as a trained machine learning model. For example, FIG. 1 shows training phase 102 where one or more machine learning algorithms 120 are being trained on training data 110 to become trained machine learning model(s) 132. Then, during inference phase 104, trained machine learning model(s) 132 can receive input data 130 and one or more inference/prediction requests 140 (perhaps as part of input data 130) and responsively provide as an output one or more inferences and/or prediction(s) 150.

As such, trained machine learning model(s) 132 can include one or more models of one or more machine learning algorithms 120. Machine learning algorithm(s) 120 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 120 and/or trained machine learning model(s) 132 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 120 and/or trained machine learning model(s) 132. In some examples, trained machine learning model(s) 132 can be trained, reside and execute to provide inferences on a particular computing device, and/or otherwise can make inferences for the particular computing device.

During training phase 102, machine learning algorithm(s) 120 can be trained by providing at least training data 110 as training input using unsupervised, supervised, semi-supervised, and/or reinforcement learning techniques. Unsupervised learning involves providing a portion (or all) of training data 110 to machine learning algorithm(s) 120 and machine learning algorithm(s) 120 determining one or more output inferences based on the provided portion (or all) of training data 110. Supervised learning involves providing a portion of training data 110 to machine learning algorithm(s) 120, with machine learning algorithm(s) 120 determining one or more output inferences based on the provided portion of training data 110, and the output inference(s) are either accepted or corrected based on correct results associated with training data 110. In some examples, supervised learning of machine learning algorithm(s) 120 can be governed by a set of rules and/or a set of labels for the training input, and the set of rules and/or set of labels may be used to correct inferences of machine learning algorithm(s) 120. Individual instances of training data 110 may be weighted according to methods described herein.

Semi-supervised learning involves having correct results for part, but not all, of training data 110. During semi-supervised learning, supervised learning is used for a portion of training data 110 having correct results, and unsupervised learning is used for a portion of training data 110 not having correct results. Reinforcement learning involves machine learning algorithm(s) 120 receiving a reward signal regarding a prior inference, where the reward signal can be a numerical value. During reinforcement learning, machine learning algorithm(s) 120 can output an inference and receive a reward signal in response, where machine learning algorithm(s) 120 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 120 and/or trained machine learning model(s) 132 can be trained using other machine learning techniques, including but not limited to, incremental learning and curriculum learning.

In some examples, machine learning algorithm(s) 120 and/or trained machine learning model(s) 132 can use transfer learning techniques. For example, transfer learning techniques can involve trained machine learning model(s) 132 being pre-trained on one set of data and additionally trained using training data 110. More particularly, machine learning algorithm(s) 120 can be pre-trained on data from one or more computing devices and a resulting trained machine learning model provided to computing device CD1, where CD1 is intended to execute the trained machine learning model during inference phase 104. Then, during training phase 102, the pre-trained machine learning model can be additionally trained using training data 110, where training data 110 can be derived from kernel and non-kernel data of computing device CD1. This further training of the machine learning algorithm(s) 120 and/or the pre-trained machine learning model using training data 110 of CD1's data can be performed using either supervised or unsupervised learning. Once machine learning algorithm(s) 120 and/or the pre-trained machine learning model has been trained on at least training data 110, training phase 102 can be completed. The trained resulting machine learning model can be utilized as at least one of trained machine learning model(s) 132.

In particular, once training phase 102 has been completed, trained machine learning model(s) 132 can be provided to a computing device, if not already on the computing device. Inference phase 104 can begin after trained machine learning model(s) 132 are provided to computing device CD1.

During inference phase 104, trained machine learning model(s) 132 can receive input data 130 and generate and output one or more corresponding inferences and/or prediction(s) 150 about input data 130. As such, input data 130 can be used as an input to trained machine learning model(s) 132 for providing corresponding inference(s) and/or prediction(s) 150 to kernel components and non-kernel components. For example, trained machine learning model(s) 132 can generate inference(s) and/or prediction(s) 150 in response to one or more inference/prediction requests 140. In some examples, trained machine learning model(s) 132 can be executed by a portion of other software. For example, trained machine learning model(s) 132 can be executed by an inference or prediction daemon to be readily available to provide inferences and/or predictions upon request. Input data 130 can include data from computing device CD1 executing trained machine learning model(s) 132 and/or input data from one or more computing devices other than CD1.

Input data 130 can include training data described herein. Other types of input data are possible as well.

Inference(s) and/or prediction(s) 150 can include task outputs, numerical values, and/or other output data produced by trained machine learning model(s) 132 operating on input data 130 (and training data 110). In some examples, trained machine learning model(s) 132 can use output inference(s) and/or prediction(s) 150 as input feedback 160. Trained machine learning model(s) 132 can also rely on past inferences as inputs for generating new inferences.

After training, the trained version of the neural network can be an example of trained machine learning model(s) 132. In this approach, an example of the one or more inference/prediction request(s)140 can be a request to predict a classification for an input training example and a corresponding example of inferences and/or prediction(s) 150 can be a predicted classification output. In some examples, individual instances of training data 110 may also have weights assigned for various possible classes as further described herein.

In some examples, one computing device CD_SOLO can include the trained version of the neural network, perhaps after training. Then, computing device CD_SOLO can receive a request to predict a task output, and use the trained version of the neural network to predict the task output.

In some examples, two or more computing devices CD_CLI and CD_SRV can be used to provide outputs; e.g., a first computing device CD_CLI can generate and send requests to predict a task output to a second computing device CD_SRV. Then, CD_SRV can use the trained version of the neural network, to predict the task output, and respond to the requests from CD_CLI for the output class. Then, upon reception of responses to the requests, CD_CLI can provide the requested output.

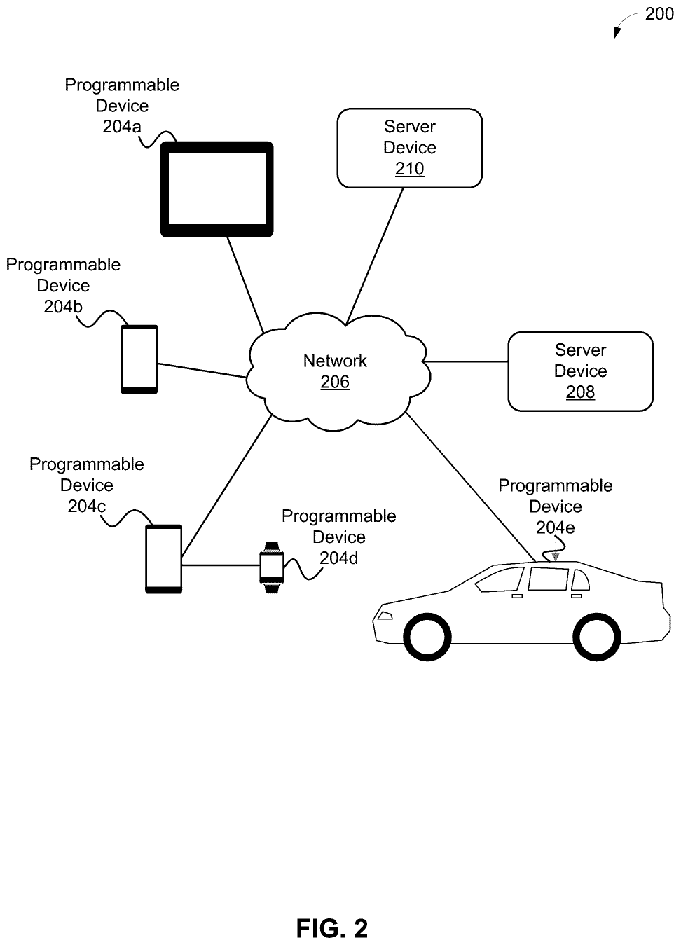

FIG. 2 depicts a distributed computing architecture 200, in accordance with example embodiments. Distributed computing architecture 200 includes server devices 208, 210 that are configured to communicate, via network 206, with programmable devices 204a, 204b, 204c, 204d, 204e. Network 206 may correspond to a local area network (LAN), a wide area network (WAN), a WLAN, a WWAN, a corporate intranet, the public Internet, or any other type of network configured to provide a communications path between networked computing devices. Network 206 may also correspond to a combination of one or more LANs, WANs, corporate intranets, and/or the public Internet.

Although FIG. 2 only shows five programmable devices, distributed application architectures may serve tens, hundreds, or thousands of programmable devices. Moreover, programmable devices 204a, 204b, 204c, 204d, 204e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 204a, 204b, 204c, 204e, programmable devices can be directly connected to network 206. In other examples, such as illustrated by programmable device 204d, programmable devices can be indirectly connected to network 206 via an associated computing device, such as programmable device 204c. In this example, programmable device 204c can act as an associated computing device to pass electronic communications between programmable device 204d and network 206. In other examples, such as illustrated by programmable device 204e, a computing device can be part of and/or inside a vehicle, such as a car, a truck, a bus, a boat or ship, an airplane, etc. In other examples not shown in FIG. 2, a programmable device can be both directly and indirectly connected to network 206.

Server devices 208, 210 can be configured to perform one or more services, as requested by programmable devices 204a-204e. For example, server device 208 and/or 210 can provide content to programmable devices 204a-204e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well. Some examples described herein involve machine learning content, such as a trained machine learning model provided as part of machine learning as a service.

As another example, server device 208 and/or 210 can provide programmable devices 204a-204e with access to software for database, search, computation, graphical, audio, video, World Wide Web/Internet utilization, and/or other functions. Many other examples of server devices are possible as well.

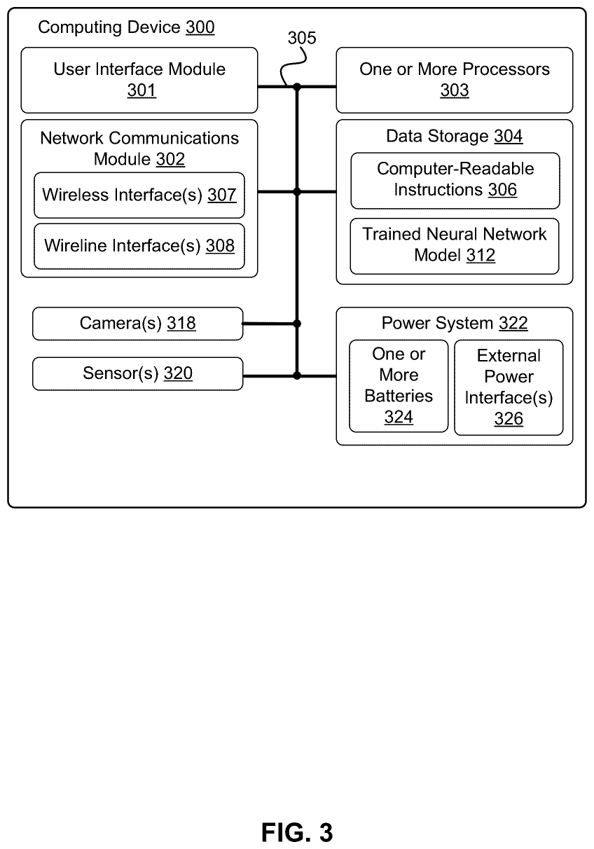

FIG. 3 is a block diagram of an example computing device 300, in accordance with example embodiments. In particular, computing device 300 shown in FIG. 3 can be configured to perform at least one function of and/or related to trained machine learning model(s) 132, and/or method 500 or method 600.

Computing device 300 may include a user interface module 301, a network communications module 302, one or more processors 303, data storage 304, one or more camera(s) 318, one or more sensors 320, and power system 322, all of which may be linked together via a system bus, network, or other connection mechanism 305.

User interface module 301 can be operable to send data to and/or receive data from external user input/output devices. For example, user interface module 301 can be configured to send and/or receive data to and/or from user input devices such as a touch screen, a computer mouse, a keyboard, a keypad, a touch pad, a trackball, a joystick, a voice recognition module, and/or other similar devices. User interface module 301 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 301 can also be configured to generate audible outputs, with devices such as a speaker, speaker jack, audio output port, audio output device, earphones, and/or other similar devices. User interface module 301 can further be configured with one or more haptic devices that can generate haptic outputs, such as vibrations and/or other outputs detectable by touch and/or physical contact with computing device 300. In some examples, user interface module 301 can be used to provide a graphical user interface (GUI) for utilizing computing device 300, such as, for example, a graphical user interface of a mobile phone device.

Network communications module 302 can include one or more devices that provide one or more wireless interface(s) 307 and/or one or more wireline interface(s) 308 that are configurable to communicate via a network. Wireless interface(s) 307 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 308 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 302 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 303 can include one or more general purpose processors, and/or one or more special purpose processors (e.g., digital signal processors, tensor processing units (TPUs), graphics processing units (GPUs), application specific integrated circuits, etc.). One or more processors 303 can be configured to execute computer-readable instructions 306 that are contained in data storage 304 and/or other instructions as described herein.

Data storage 304 can include one or more non-transitory computer-readable storage media that can be read and/or accessed by at least one of one or more processors 303. The one or more computer-readable storage media can include volatile and/or non-volatile storage components, such as optical, magnetic, organic or other memory or disc storage, which can be integrated in whole or in part with at least one of one or more processors 303. In some examples, data storage 304 can be implemented using a single physical device (e.g., one optical, magnetic, organic or other memory or disc storage unit), while in other examples, data storage 304 can be implemented using two or more physical devices.

Data storage 304 can include computer-readable instructions 306 and perhaps additional data. In some examples, data storage 304 can include storage required to perform at least part of the herein-described methods, scenarios, and techniques and/or at least part of the functionality of the herein-described devices and networks. In some examples, data storage 304 can include storage for a trained neural network model 312 (e.g., a model of trained neural networks such as trained machine learning model(s) 132). In particular of these examples, computer-readable instructions 306 can include instructions that, when executed by one or more processors 903, enable computing device 300 to provide for some or all of the functionality of trained neural network model 312.

In some examples, computing device 300 can include one or more camera(s) 318. Camera(s) 318 can include one or more image capture devices, such as still and/or video cameras, equipped to capture light and record the captured light in one or more images; that is, camera(s) 318 can generate image(s) of captured light. The one or more images can be one or more still images and/or one or more images utilized in video imagery. Camera(s) 318 can capture light and/or electromagnetic radiation emitted as visible light, infrared radiation, ultraviolet light, and/or as one or more other frequencies of light.

In some examples, computing device 300 can include one or more sensors 320. Sensors 320 can be configured to measure conditions within computing device 300 and/or conditions in an environment of computing device 300 and provide data about these conditions. For example, sensors 320 can include one or more of: (i) sensors for obtaining data about computing device 300, such as, but not limited to, a thermometer for measuring a temperature of computing device 300, a battery sensor for measuring power of one or more batteries of power system 322, and/or other sensors measuring conditions of computing device 300; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 300, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 300, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 300, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 320 are possible as well.

Power system 322 can include one or more batteries 324 and/or one or more external power interfaces 326 for providing electrical power to computing device 300. Each battery of the one or more batteries 324 can, when electrically coupled to the computing device 300, act as a source of stored electrical power for computing device 300. One or more batteries 324 of power system 322 can be configured to be portable. Some or all of one or more batteries 324 can be readily removable from computing device 300. In other examples, some or all of one or more batteries 324 can be internal to computing device 300, and so may not be readily removable from computing device 300. Some or all of one or more batteries 324 can be rechargeable. For example, a rechargeable battery can be recharged via a wired connection between the battery and another power supply, such as by one or more power supplies that are external to computing device 300 and connected to computing device 300 via the one or more external power interfaces. In other examples, some or all of one or more batteries 324 can be non-rechargeable batteries.

One or more external power interfaces 326 of power system 322 can include one or more wired-power interfaces, such as a USB cable and/or a power cord, that enable wired electrical power connections to one or more power supplies that are external to computing device 300. One or more external power interfaces 326 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 326, computing device 300 can draw electrical power from the external power source the established electrical power connection. In some examples, power system 322 can include related sensors, such as battery sensors associated with the one or more batteries or other types of electrical power sensors.

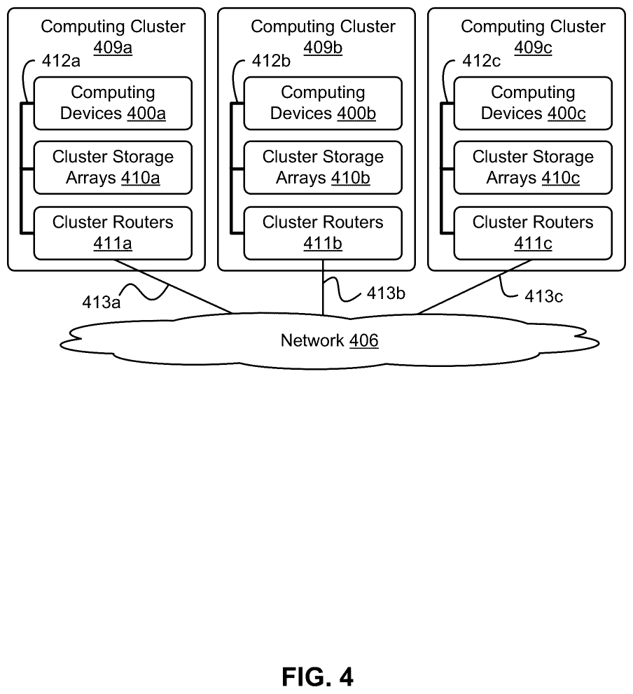

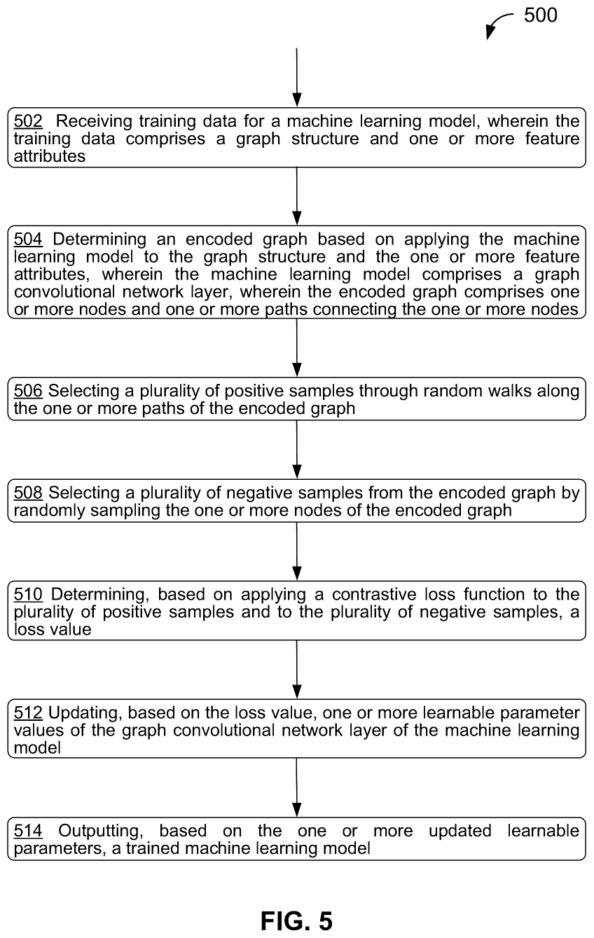

FIG. 4 depicts a cloud-based server system in accordance with an example embodiment. In FIG. 4, functionality of a neural network, and/or a computing device can be distributed among computing clusters 409a, 409b, 409c. Computing cluster 409a can include one or more computing devices 400a, cluster storage arrays 44a, and cluster routers 411a connected by a local cluster network 412a. Similarly, computing cluster 409b can include one or more computing devices 400b, cluster storage arrays 44b, and cluster routers 411b connected by a local cluster network 412b. Likewise, computing cluster 409c can include one or more computing devices 400c, cluster storage arrays 44c, and cluster routers 411c connected by a local cluster network 412c.

In some embodiments, computing clusters 409a, 409b, 409c can be a single computing device residing in a single computing center. In other embodiments, computing clusters 409a, 409b, 409c can include multiple computing devices in a single computing center, or even multiple computing devices located in multiple computing centers located in diverse geographic locations. For example, FIG. 4 depicts each of computing clusters 409a, 409b, 409c residing in different physical locations.

In some embodiments, data and services at computing clusters 409a, 409b, 409c can be encoded as computer readable information stored in non-transitory, tangible computer readable media (or computer readable storage media) and accessible by other computing devices. In some embodiments, computing clusters 409a, 409b, 409c can be stored on a single disk drive or other tangible storage media, or can be implemented on multiple disk drives or other tangible storage media located at one or more diverse geographic locations.

In some embodiments, each of computing clusters 409a, 409b, and 409c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 409a, for example, computing devices 400a can be configured to perform various computing tasks of a conditioned, axial self-attention based neural network, and/or a computing device. In one embodiment, the various functionalities of a neural network, and/or a computing device can be distributed among one or more of computing devices 400a, 400b, 400c. Computing devices 400b and 400c in respective computing clusters 409b and 409c can be configured similarly to computing devices 400a in computing cluster 409a. On the other hand, in some embodiments, computing devices 400a, 400b, and 400c can be configured to perform different functions.

In some embodiments, computing tasks and stored data associated with a neural network, and/or a computing device can be distributed across computing devices 400a, 400b, and 400c based at least in part on the processing requirements of a neural network, and/or a computing device, the processing capabilities of computing devices 400a, 400b, 400c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 44a, 44b, 44c of computing clusters 409a, 409b, 409c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a conditioned, axial self-attention based neural network, and/or a computing device can be distributed across computing devices 400a, 400b, 400c of computing clusters 409a, 409b, 409c, various active portions and/or backup portions of these components can be distributed across cluster storage arrays 410a, 410b, 410c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 411a, 411b, 411c in computing clusters 409a, 409b, 409c can include networking equipment configured to provide internal and external communications for the computing clusters. For example, cluster routers 411a in computing cluster 409a can include one or more internet switching and routing devices configured to provide (i) local area network communications between computing devices 400a and cluster storage arrays 410a via local cluster network 412a, and (ii) wide area network communications between computing cluster 409a and computing clusters 409b and 409c via wide area network link 413a to network 406. Cluster routers 411b and 411c can include network equipment similar to cluster routers 411a, and cluster routers 411b and 411c can perform similar networking functions for computing clusters 409b and 409b that cluster routers 411a perform for computing cluster 409a.

In some embodiments, the configuration of cluster routers 411a, 411b, 411c can be based at least in part on the data communication requirements of the computing devices and cluster storage arrays, the data communications capabilities of the network equipment in cluster routers 411a, 411b, 411c, the latency and throughput of local cluster networks 412a, 412b, 412c, the latency, throughput, and cost of wide area network links 413a, 413b, 413c, and/or other factors that can contribute to the cost, speed, fault-tolerance, resiliency, efficiency and/or other design criteria of the moderation system architecture.

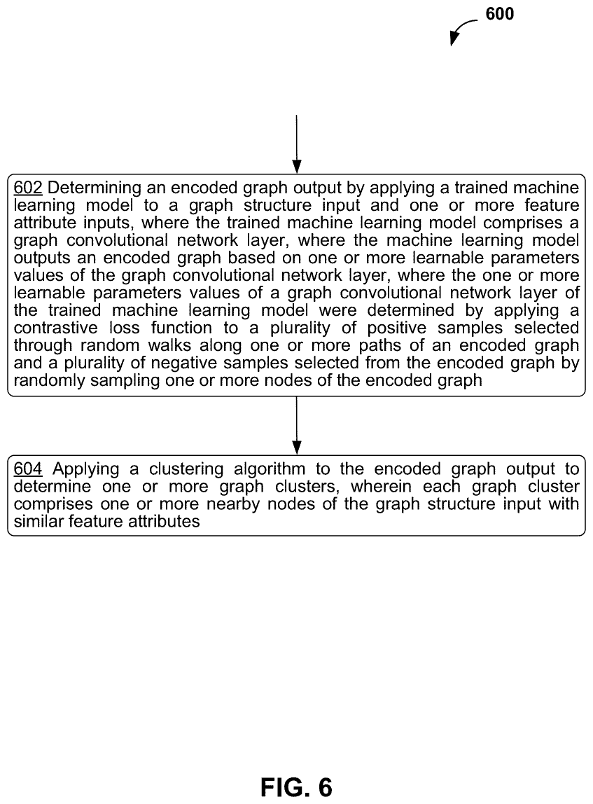

FIG. 5 is a flow chart of method 500 of training a machine learning model, in accordance with example embodiments. Method 500 may be executed by one or more processors.

At block 502, method 500 may include receiving training data for the machine learning model, wherein the training data comprises a graph structure and one or more feature attributes.

At block 504, method 500 may include determining an encoded graph based on applying the machine learning model to the graph structure and the one or more feature attributes, wherein the machine learning model comprises a graph convolutional network layer, wherein the encoded graph comprises one or more nodes and one or more paths connecting the one or more nodes.

At block 506, method 500 may include selecting a plurality of positive samples through random walks along the one or more paths of the encoded graph.

At block 508, method 500 may include selecting a plurality of negative samples from the encoded graph by randomly sampling the one or more nodes of the encoded graph.

At block 510, method 500 may include determining, based on applying a contrastive loss function to the plurality of positive samples and to the plurality of negative samples, a loss value.

At block 512, method 500 may include updating, based on the loss value, one or more learnable parameter values of the graph convolutional network layer of the machine learning model.

In some embodiments, the machine learning model consists of a single layer, wherein the single layer is the graph convolutional network layer.

In some embodiments, the machine learning model further comprises a parametric rectified linear unit activation function.

In some embodiments, the machine learning model further comprises a L2 normalization function.

In some embodiments, the method of training the machine learning model may be self-supervised.

In some embodiments, a quantity of the one or more learnable parameter values may be based on a dimension of the one or more feature attributes.

In some embodiments, the method of training the machine learning model may use a quantity of memory based on a batch size, an average degree of nodes, and a dimension of the one or more feature attributes.

In some embodiments, the training data may comprise a plurality of mini-batches, wherein determining the encoded graph comprises applying the machine learning model to a mini-batch of the plurality of mini-batches.

In some embodiments, the graph structure may comprise a plurality of nodes and a plurality of paths each connecting a node of the plurality of nodes to another node of the plurality of nodes.

In some embodiments, determining the encoded graph based on applying the machine learning model to the graph structure and the one or more feature attributes may comprise determining, based on graph structure and the one or more feature attributes, a normalized adjacency matrix and a k-hop diffusion matrix, applying the machine learning model to the normalized adjacency matrix and the k-hop diffusion matrix to obtain an encoded normalized adjacency matrix and an encoded k-hop diffusion matrix, and determining the encoded graph by normalizing a sum of the encoded normalized adjacency matrix, the encoded k-hop diffusion matrix, and a learnable matrix.

In some embodiments, a time complexity of training the machine learning model may vary linearly based on the number of nodes.

In some embodiments, the training data may comprise a plurality of mini-batches of a predetermined size, wherein determining the encoded graph comprises applying the machine learning model to a mini-batch of the plurality of mini-batches, wherein a time complexity of training the machine learning model varies linearly based on the predetermined size.

In some embodiments, selecting the plurality of positive samples through random walks along the one or more paths of the encoded graph may comprise using a biased second order random walk through the encoded graph to obtain the plurality of positive samples.

In some embodiments, the random walk may start at a particular node, wherein selecting the plurality of positive samples through random walks along the one or more paths of the encoded graph comprises determining one or more similar nodes of the encoded graph that are similar to the particular node at which the random walk starts.

In some embodiments, method 500 may include determining a node set by taking a union of the plurality of positive samples and the plurality of negative samples.

In some embodiments, applying a contrastive loss function to the plurality of positive samples and to the plurality of negative samples may result in a linearly separable representation.

In some embodiments, method 500 may be carried out by a single virtual machine.

FIG. 6 is a flow chart of method 600 of applying a machine learning model, in accordance with example embodiments. Method 600 may be executed by one or more processors.

At block 602, method 600 may include determining an encoded graph output by applying a trained machine learning model to a graph structure input and one or more feature attribute inputs, where the trained machine learning model comprises a graph convolutional network layer, where the machine learning model outputs an encoded graph based on one or more learnable parameters values of the graph convolutional network layer, where the one or more learnable parameters values of a graph convolutional network layer of the trained machine learning model were determined by applying a contrastive loss function to a plurality of positive samples selected through random walks along one or more paths of an encoded graph and a plurality of negative samples selected from the encoded graph by randomly sampling one or more nodes of the encoded graph.

At block 604, method 600 may include applying a clustering algorithm to the encoded graph output to determine one or more graph clusters, wherein each graph cluster comprises one or more nearby nodes of the graph structure input with similar feature attributes.

In some embodiments, the clustering algorithm may be a k-means clustering algorithm.

In some embodiments, applying a clustering algorithm to the encoded graph output to determine the one or more graph clusters may comprise determining a finite number of graph clusters.

In some embodiments, the encoded graph output may comprise one or more vector embeddings, wherein each of the one or more vector embeddings corresponds to a node of the graph structure input.

In some embodiments, determining an encoded graph output by applying the trained machine learning model to a graph structure input and one or more feature attribute inputs may comprise determining, based on graph structure input and the one or more feature attribute inputs, a normalized adjacency matrix and a k-hop diffusion matrix, applying the machine learning model to the normalized adjacency matrix and the k-hop diffusion matrix to obtain an encoded normalized adjacency matrix and an encoded k-hop diffusion matrix, and determining the encoded graph by adding the encoded normalized adjacency matrix, the encoded k-hop diffusion matrix, and a learnable matrix.

In some embodiments, a system may include a processor and a non-transitory computer-readable medium having stored thereon instructions that, when executed by the processor, cause the processor to perform operations in accordance with any of methods described above and/or below.

In some embodiments, a non-transitory computer-readable medium having stored thereon instructions that, when executed by a computing device, may cause the computing device to perform operations in accordance with any of the methods described above and/or below.

### III. Example Applications

In some examples, the methods of training the machine learning model and/or the methods of applying the trained machine learning model as described herein may be applied to predicting user preferences and/or to recommend various content (e.g., articles, books, movies, etc.). For example, the machine learning model may be applied to a data set including various users and their preferences as attributes, and the machine learning model may predict groupings for the various users. Users of the same group may be predicted to have similar preferences.

In some examples, the methods of training the machine learning model and/or methods of applying the trained machine learning model as described herein may be applied to routing, e.g., routing sensor data within a network. For example, the methods described herein may facilitate determining the most efficient route to send data collected by a sensor within a network to a computing device.

In some embodiments, the methods of training the machine learning model and/or methods of applying the trained machine learning model as described herein may be applied to triaging, which may facilitate efficient treatment of patients.

In some embodiments, the methods of training the machine learning model and/or the methods of applying the trained model as described herein may facilitate groupings of people, perhaps those that would work well together on projects.

In some embodiments, the methods of training the machine learning model and/or the methods of applying the trained model as described herein may facilitate data analysis.

In some embodiments, the methods of training the machine learning model and/or the methods of applying the trained model as described herein may be applied to clustering patients with various symptoms and/or diseases.

In some embodiments, the methods of training the machine learning model and/or the methods of applying the trained model as described herein may be applied to grouping patients with similar health attributes (e.g., taking the same class of medication, having similar health conditions, etc.). Grouping patients with similar health attributes may facilitate predicting future prescriptions, future diseases, among other possibilities.

In some embodiments, the methods of training the machine learning model and/or the methods of applying the trained model as described herein may be applied to drugs with various attributes (e.g., being given to certain patients, patient symptoms before and after using the drug, etc.), which may facilitate predicting which known drugs may be useful in treating diseases that it is not intended to treat.

In some embodiments, the methods of training the machine learning model and/or the methods of applying the trained model as described herein may facilitate predicting chemical structures of compounds that may be useful in treating various diseases. For example, the methods described herein may be applied to various known compounds and their known uses, and the model may facilitate associations between known drugs and other compounds.

In some embodiments, the methods of training the machine learning model and/or the methods of applying the trained model as described herein may facilitate predicting causes of diseases.

In some embodiments, the methods of training the machine learning model and/or the methods of applying the trained model as described herein may facilitate predicting other biological concepts, including gene expression, protein folding, gene mutations, protein mutations, among other examples.

### IV. Example Technical Benefits

In some examples, the methods of training the machine learning model and/or the methods of applying the trained model as described herein may enable graphs with additional feature attributes associated with one or more nodes to be clustered. In particular, the methods described herein may combine information from both the graph view and the feature view, which may facilitate the machine learning model performing better when the graph view and/or the feature view is noisy and/or incomplete.

In some examples, the methods of training the machine learning model and/or the methods of applying the trained model as described herein may enable large scale graph clustering. For example, datasets used to train the machine learning model may include millions of nodes, and/or test data for the trained machine learning model may include millions of nodes.

In some examples, the methods of training the machine learning model and/or the methods of applying the trained model as described herein may enable less memory to be used for clustering large scale data.

In some examples, the methods of training the machine learning model and/or the methods of applying the trained model as described herein may enable scalable clustering. For example, memory usage and/or time usage may vary linearly with respect to the number of nodes, the average degree of nodes, and batch size.

In some examples, the methods of training the machine learning model and/or the methods of applying the trained model as described herein may facilitate linear separability and clustering.

In some examples, the methods of training the machine learning model and/or the methods of applying the trained model as described herein may enable millions of nodes to be clustered using a single virtual machine. In particular, this scalability may be enabled by the light-weight encoder (e.g., the machine learning model including a single layer) and the light-weight random walk algorithm.

In some examples, the methods of training the machine learning model and/or the methods of applying the trained model as described herein may facilitate the ability to cluster input graph structures and feature attributes into a set number of clusters.

In some examples, the methods of training the machine learning model and/or the methods of applying the trained model as described herein may facilitate determination of higher quality clusters (e.g., as evaluated using normalized mutual information score).

In some examples, the methods of training the machine learning model and/or the methods of applying the trained model as described herein may be able to be completed without the use of labeled data. Instead, training the machine learning model may be based on unsupervised training using a contrastive loss function to compare nodes determined from random walks and random sampling. The trained model may be applied to various other data.

In some examples, the methods of training the machine learning model and/or the methods of applying the trained model as described herein may have the advantage of being parallelizable, thereby enabling further scalability.

In some examples, the methods of training the machine learning model and/or the methods of applying the machine learning model as described herein may enable quick analysis and/or application of the outputs, as the machine learning model may output vector embeddings that are each associated with each node of a graph structure input.

### V. Technical Description

The problem of clustering graphs with additional side-information of node features is studied. The problem is extensively studied, and several existing methods exploit Graph Neural Networks to learn node representations. However, most of the existing methods focus on generic representations instead of their cluster-ability or do not scale to large scale graph datasets. In this work, we propose S³GC which uses contrastive learning along with Graph Neural Networks and node features to learn clusterable features. We empirically demonstrate that S3GC is able to learn the correct cluster structure even when graph information or node features are individually not informative enough to learn correct clusters. Finally, using extensive evaluation on a variety of benchmarks, we demonstrate that S³GC is able to significantly outperform state-of-the-art methods in terms of clustering accuracy—with as much as 5% gain in NMI—while being scalable to graphs of size 100M.

### Section 1

Graphs are commonplace data structures to store information about entities/users, and have been investigated for decades. In modern ML systems, the entities/nodes are often equipped with vector embeddings from different sources. For example, authors are nodes in a citation graph and can be equipped with embeddings of the title/content of the authored papers as relevant side information. Owing to the utility of graphs in large-scale systems, tremendous progress has been made in the domain of supervised learning from graphs and node features, with Graph Neural Networks (GNNs) headlining the state-of-the-art methods. However, typical realworld ML workflows start with unsupervised data analysis to better understand the data and design supervised methods accordingly. In fact, many times clustering is a key tool to ensure scalability to web-scale data. Furthermore, even independent of supervised learning, clustering the graph data with node features is critical for a variety of real-world applications like recommendation, routing, triaging etc.

Effective graph clustering methods should be scalable, especially with respect to the number of nodes, which can be in millions even for a moderate-scale system. Furthermore, in the presence of side-information, the system should be able to use both the views—node features and graph information—of the data “effectively”. For example, the method should be more accurate than single-view methods that either consider only the graph information or only the node feature information. This problem of graph clustering with side information has been extensively studied in the literature; see Section 2 for a review of the existing and recent methods. Most methods map the problem to that of learning vector embeddings and then apply standard k-means style clustering techniques. However, such methods—like Node2vec—don't explicitly optimize for clusterability, therefore the resulting embeddings might not be suitable for effective clustering. Furthermore, several existing methods tend to be highly reliant on the graph information and thus tend to perform poorly when graph information is noisy/incomplete. Finally, several existing methods such as GraphCL propose expensive augmentation and training modules, and thus do not scale to realistic web-scale datasets.

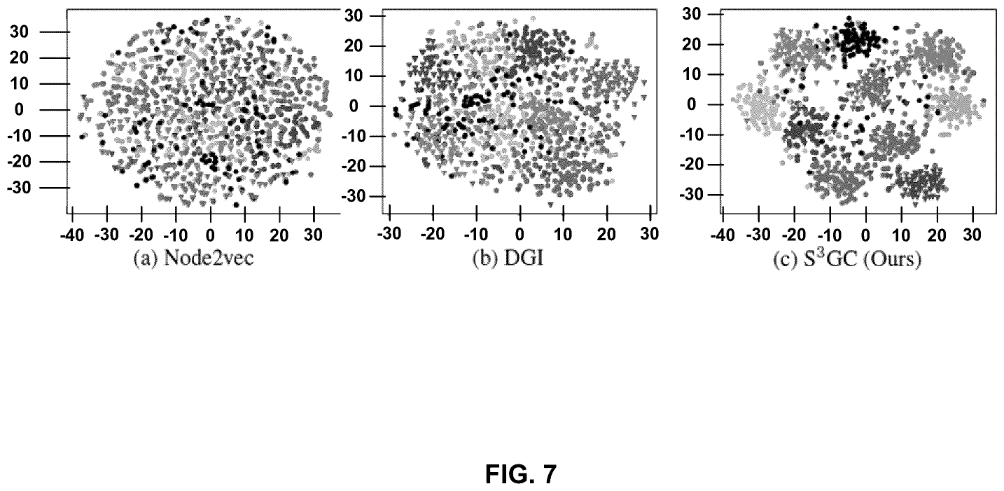

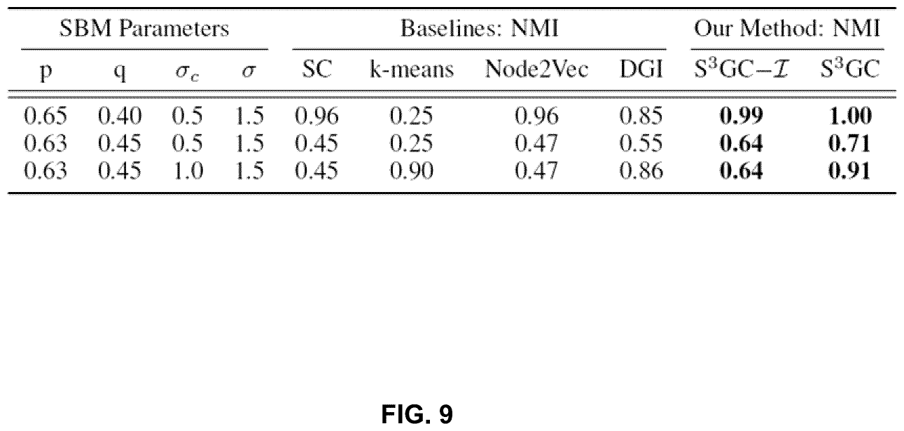

FIG. 7: tSNE visualization of embeddings when applied to the data model given in Section 3.5. SBM parameters p,q are such p=q+0.18, while σ_{c}=σ−0.1, i.e., both graph information and feature information are separately insufficient for clustering (see FIG. 9). S3GC is able to well-separate all the clusters while Node2vec and DGI have a significant amount of cluster overlap.

Scalable self-supervised graph clustering (S³GC) is proposed. S³GC uses a one-layer GNN encoder to combine both the graph and node-feature information, along with graph only and node feature only encodings. S³GC applies contrastive learning to ensure that the embedding of a node is close to “near-by” nodes—obtained by random walk—while being far away from all other nodes. That is, S³GC explicitly addresses the above three mentioned challenges: a) S³GC is based on contrastive learning which is known to promote linear separability and hence clustering, b) S³GC carefully combines information from both the graph view and the feature view, thus performs well when one of the views is highly noisy/incomplete, c) S³GC use a light-weight encoder and simple random walk based sampler/augmentation, and can be scaled to hundreds of millions of nodes on a single virtual machine (VM).

For example, consider a dataset where the adjacency matrix of the graph is sampled from a stochastic block model with 10 clusters; let probability of an edge between nodes from same cluster is p and from different clusters is q. Furthermore, features of each node are also sampled from a mixture of 10 Gaussians where σ_{c} is the distance between any two cluster centers while o is the standard deviation of each Gaussian. Now, consider a setting where p>q but p, q are close, hence information from the graph structure is weak. Similarly, σ_{c}<σ but they are close. FIG. 7 plots two-dimensional tSNE projection of embeddings learned by the state-of-the-art Node2vec and DGI methods, along with S³GC. Note that while Node2vec's objective function is optimized well, the embeddings do not appear to be separable. DGI's embeddings are better separated, still there is a significant overlap. In contrast, S³GC is able to produce well-separated embeddings due to the contrastive learning objective along with explicit utilization of both data views.

We conduct extensive empirical evaluation of S³GC and compare it to a variety of baselines and standard state-of-the-art benchmarks, particularly: Spectral Clustering, k-means, METIS, Node2vec, DGI, GRACE, MVGRL and BGRL. Overall, we observe that our method consistently outperforms Node2vec, DGI—SOTA scalable methods—on all seven datasets, achieving as much as 5% higher NMI than both the methods. For two small scale datasets, our method is competitive with MVGRL method, but MVGRL does not scale to even moderate sized datasets with about 2.5M nodes and 61M edges, while our method scales to datasets with 111M nodes and 1.6B edges.

### Section 2. Related Work

Below, we discuss works related to various aspects of graph clustering and self-supervised learning, and place our contribution in the context of these related works.

Graph OR features-only clustering: Graph clustering is a well-studied problem, and several techniques address the problem including Spectral Clustering (SC), Graclus, METIS, Node2vec, and DeepWalk. In particular, Node2Vec is a probabilistic framework that is an extension to DeepWalk, and maps nodes to low-dimensional feature spaces such that the likelihood of preserving the local and global neighborhood of the nodes is maximized. In the setting of node-features only data, k-means clustering is one of the classical methods, in addition to several others like agglomerative clustering, density based clustering, and deep clustering.

As demonstrated in FIG. 7 and FIG. 9, S³GC attempts to exploit both the views, and if both views are meaningful then it can be significantly more accurate than single-view methods.

Self Supervised Learning: Self-supervised learning methods have demonstrated that they can learn linearly separable features/representations in the absence of any labeled information. Typical approach is to define instance-wise “augmentations” and then pose the problem as that of learning contrastive representations that map instance augmentations close to the instance embedding, while pushing it far apart from all other instance embeddings. Popular examples include MoCo, MoCo v2, SimCLR, and BYOL. Such methods require augmentations, and as such do not apply directly to the graph+node-features clustering problem. S³GC uses simple random walk based augmentations to enable contrastive learning based techniques.

Graph Clustering with Node Features: To exploit both the graph and feature information, several existing works use the approach of autoencoder. That is, they encode nodes using Graph Neural Networks (GNN), with the goal that inner-product of encodings can reconstruct the graph structure; GAE and VGAE use this technique.

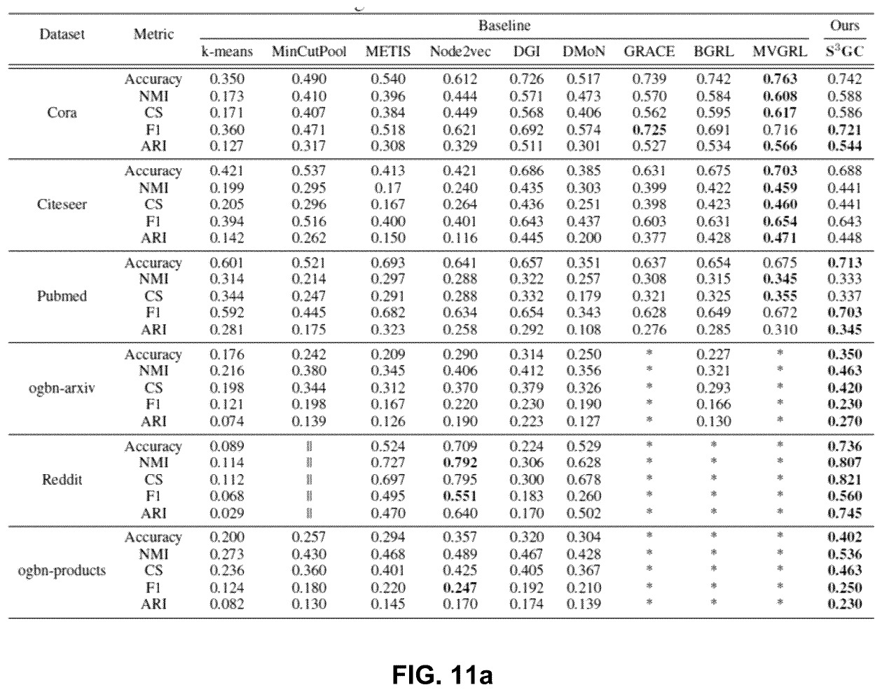

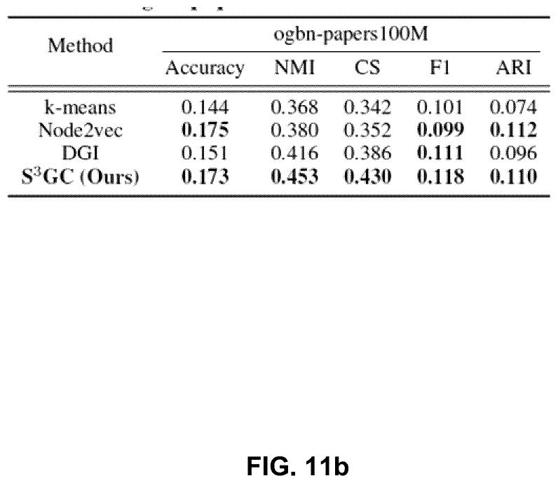

GALA, ARGA and ARVGA extend the idea by using Laplacian Sharpening and generative adversarial learning. Structural Deep Clustering Network (SDCN) jointly learns an Auto-Encoder (AE) along with a Graph Auto-Encoder (GAE) for better node representations, while Deep Fusion Clustering Network (DFCN) merges the representations learned by AE and GAE for consensus representation learning. Since AE type approaches attempt to solve a much harder problem, their accuracy in practice lags significantly to the state-of-the-art; for example, see FIG. 11a in which shows that such techniques can be 5-8% less accurate. MinCutPool and DMoN extend spectral clustering with graph encoders, but the resulting problem is somewhat unstable and leads to relatively poor partitions; see FIG. 11a.

Graph Contrastive Learning: Recently several papers have explored contrastive Graph Representation Learning based approaches and have demonstrated state-of-the-art performance. Deep Graph Infomax (DGI) is based on MINE method, and is one of the most scalable method with nearly SOTA performance. It uses edge permutations to learn augmentations and embeddings.

Infograph extends the DGI idea to learn unsupervised representations for graphs as well. GraphCL design a framework with four types of graph augmentations for learning unsupervised representations of graph data using a contrastive objective. MVGRL extends these ideas by performing node diffusion and contrasting node representations with augmented graph representations while GRACE maximizes agreement of node embeddings across two corrupted views of the graph. Bootstrapped Graph Latents (BGRL) adapts the BYOL methodology to the graph domain, and eliminates the need for negative sampling by minimizing an invariance based loss for augmented graphs within a batch. While these methods are able to obtain more powerful embeddings, the augmentations and objective function setup become expensive, and hence they are hard to scale to large datasets beyond □1M nodes. In contrast, S³GC is able to provide competitive or better clustering accuracy, while still being scalable to graphs of size 100M nodes.

### Section 3 S³GC: Scalable Self-Supervised Graph Contrastive Clustering

In this section, we first formally introduce the problem of graph clustering and notations. Then we discuss challenges faced by the current methods and outline the framework of our method S³GC. Finally, we detail each component of our method and highlight the overall training methodology.

### Section 3.1 Problem Statement and Notations

Consider a graph G=(V,E) with the vertex set V={v₁, . . . , vₙ} and the edge set E□V×V, where |E|=m. Let A□R^{n×n} be the adjacency matrix of G, where Aᵢⱼ=1 if (vᵢ, vⱼ) □E, else Aᵢⱼ=0. Let X□R^{n×d} be the node attributes or feature matrix, where the i-th row Xᵢ denotes the d-dimensional feature vector of node i. Given the graph G and attributes X, the aim is to partition the graph G into k partitions {G₁, G₂, G₃, . . . , Gₖ} such that nodes in the same cluster are similar/close to each other in terms of the graph structure as well as in terms of attributes.

Now, in general, one can define several loss functions to evaluate quality of clustering but that might not reflect the underlying ground truth. So, to evaluate the quality of clustering, we use standard benchmarks which have ground truth labels apriori. Furthermore, Normalized Mutual Information (NMI) between the ground truth labels and the estimated cluster labels is used as the key metric. NMI between two labellings Y₁ and Y₂ is defined as:

$$NMI ( {Y}_{1} , {Y}_{2} ) = \frac{2 \cdot I ( {Y}_{1} , {Y}_{2} )}{H ( {Y}_{1} ) + H ( {Y}_{2} )} \qquad Equation 1$$

where I(Y₁, Y₂) is the Mutual Information between labellings Y₁ and Y₂, and H(·) is the entropy. Normalized Adjacency Matrix is denoted by A=D^{-1/2} AD^{-1/2}ϵR^{n×n} where D=diag (AlN) is the degree matrix. We also compute a k-hop Diffusion Matrix, denoted by S_{K}=Σᵢ₌₀^{k}αᵢAⁱϵR^{n×3} where αᵢ□[0, 1] □i□[k], and Σᵢ₌₀αᵢ≤1. Intuitively, k-hop diffusion matrix captures a weighted average of k-hop neighbourhood around every node. For specific αi and for k=∞, diffusion matrix can be computed in closed form. However, in this work we focus on finite k.

### Section 3.2 Challenges in Graph Clustering

Clustering in general is a challenging problem as the underlying function to evaluate quality of the clustering solution is unknown apriori. However, graph partitioning/clustering with attributes poses several more challenges. In particular, scaling the methods is challenging as graphs are sparse data structures, while neural network based approaches produce dense artifacts. Furthermore, it is challenging to effectively combine information from the two data views: graph and the feature attributes. Node2vec uses only graph structure information, DGI and related methods are highly dependent upon attribute quality. Motivated by the above mentioned challenges, we propose S³GC which uses a self-supervised variant of GNNs.

### Section 3.3 S³GC: Scalable Self Supervised Graph Clustering—Methodology

At a high level, S³GC uses a Graph Convolution Network (GCN) based encoder and optimizes it using a contrastive loss where the nodes are sampled via a random walk. Below we describe the three components of S³GC and then provide the resulting training algorithm.

Graph Convolutional Encoder: We use a 1-layer Graph Convolutional Network to encode the graph and feature information for each node:

Equation 2:

where XϵR^{n×\hat{d}} stores the learned -dimensional representation of each node. Recall that A is the normalized adjacency matrix and S_{K} is the k-hop diffusion matrix. IϵR^{n×\hat{d}} is a learnable matrix. Norm is L2-normalization of the embeddings, {Θ,Θ′} are the weights of the GCN layer, and PRELU is the parameteric ReLU activation function:

f(zᵢ)=zᵢ if zᵢ≥0, f(zᵢ)=α·zᵢ Equation 3:

otherwise

where a is a learnable parameter. Our choice of encoder makes the method scalable as a 1-layer GCN requires storing only the learnable parameters in the GPU/memory, which is small (O(d²), where d is the dimensionality of the node attributes). The parameter I scales only linearly with the number of nodes n. More importantly, we use mini-batches that reduce the memory requirement of forward and backward pass to order O(rsd+d²) where r is the batch size in consideration and s is the average degree of nodes, therefore making our method scalable to graphs of very large sizes as well. We provide further discussion on memory requirement of our method in Section 3.4.

RandomWalk Sampler: Next, inspired by, we utilise biased second order Random Walks with restarts to generate points similar to a given node and thus capture the local neighborhood of each node. Formally following, we start with a source node u, and simulate a random walk of length l. We use ci to denote the i-th node in the random walk starting from c₀=u. Every other node in walk ci is generated from the distribution:

$$P ( {c}_{i} = x \vert {c}_{i - 1} = v ) = \frac{{π}_{vx}}{z} , if if ( v , x ) ϵ E , \qquad Equation 4$$

$$( {c}_{i} = x \vert {c}_{i - 1} = v ) ) = 0 otherwise$$

where πᵥₓ is the unnormalized transition probability between nodes v and x and Z is the normalization constant. To bias the random walks and compute the next edge x we follow a methodology similar to, and from node v after traveling (t, v), the transition probability πᵥₓ is set to α_{pq}(t, x)· wᵥₓ where wᵥₓ is the weight on the edge between v and x, and the bias parameter α is defined by:

$${α}_{pq} ( t , x ) = \frac{1}{p} , if {d}_{tx} = 0 , {α}_{pq} ( t , x ) = 1 , \qquad Equation 5$$

$$if {d}_{tx} = 1 {alpha}_{pq} ( t , x ) = \frac{1}{q} if {d}_{tx} = 2$$

where p is the return parameter, controlling the likelihood of immediately revisiting a node, q is the in-out parameter, allowing the search to differentiate between “inward” and “outward” nodes, and dₜₓ denotes the shortest path distance between nodes t and x. We note that d^{tx} from node t to x can only take values □{0, 1, 2}. Setting p to a high value (>max(q, 1)) ensures a lesser likelihood of revisiting a node and setting it to a low value (<min(q, 1)) would make the walk more “local”. Similarly, setting q>1 would bias the random walk to nodes near t and obtain a local view of the graph encouraging BFS-like behaviour, whereas a q<1 would bias the walk towards nodes further away from t and encourage DFS-like behaviour.

Contrastive Loss Formulation: Now to learn the encoder parameters, we use SimCLR style loss function where nodes generated from the random walk are considered to be positives while rest of the samples are considered to be negative. That is, we use graph neighborhood information to produce augmentations of a node. Formally, let C(u)+={c₀, c₁, . . . , c₁} be the nodes generated by a random walk starting at c₀=u. Then, C(u) is the set of positive samples p⁺ᵤ, while the set of negatives p⁻ᵤ is generated by sampling 1 nodes from the remaining set of nodes [n]\p⁺ᵤ. Given p⁺ᵤ and p⁻ᵤ, we can now define the loss for each u as:

$$\frac{{Σ}_{v ϵ {p}_{u}^{+}} exp ( sim ( {\underline{X}}_{u} , {\underline{X}}_{v} )}{{Σ}_{v ϵ {p}_{u}^{+}} exp ( sim ( {\underline{X}}_{u} , {\underline{X}}_{v} ) + {Σ}_{{v}^{′} ϵ {p}_{u}^{-}} exp ( sim ( {\underline{X}}_{u} , {\underline{X}}_{{v}^{′}} )} \qquad Equation 6$$

where sim is some similarity function, for example inner product:

$$sim ( u , v ) = \frac{{u}^{T} v}{‖ u ‖ ‖ v ‖} .$$

Note that SimCLR style loss functions have been shown to lead to “linearly separable” representations and hence aligns well with the clustering objective. In contrast, loss functions like those used in Node2vec might not necessarily lead to “clusterable” representations which is also indicated by their performance on synthetic as well as real-world datasets.

### Section 3.4 Algorithm

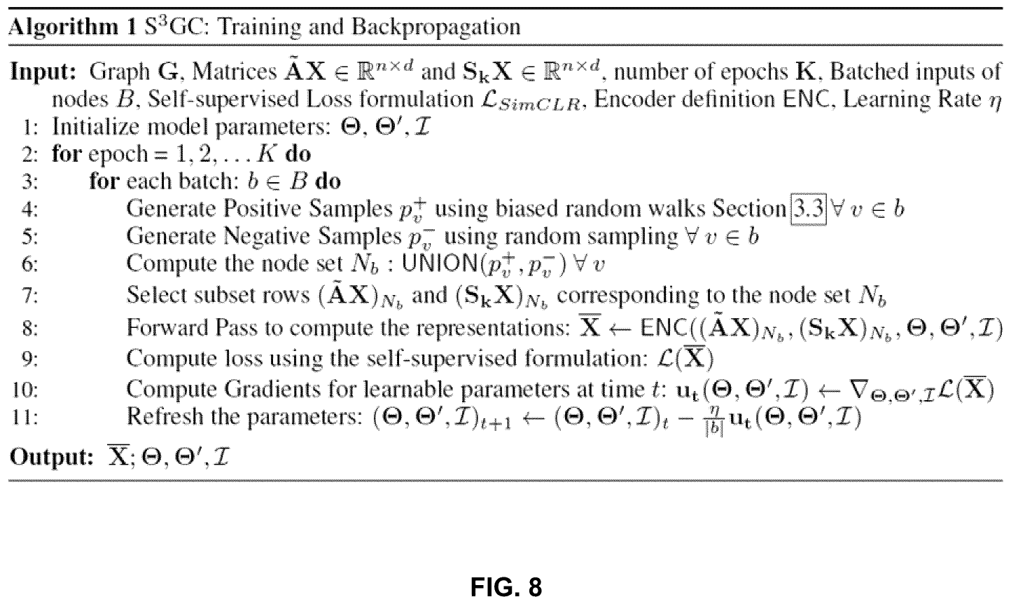

Now that we have discussed the individual components of our method, we describe the overall training methodology in FIG. 8. We begin with the initialization of the learnable parameters in line 1. In line 4,5 we generate the positive and negative samples for each node in the current batch. Since we operate with embeddings of only the nodes in batch and their positive/negative samples, we take a union of these to create a “node set” in line 6. This helps in reducing the memory requirements of our algorithm, since we do not do forward/backward pass on the entire AX, but only on the nodes needed for the current batch. Once we have the node set, we compute representations for the nodes in the current batch using a forward pass in line 8, compute the loss for nodes in this set in line 9, and perform back-propagation to generate the gradient updates for the learnable parameters in line 10. Finally, we update the learnable parameters in line 11 and repeat the process for the next batch.

Space Complexity: The space complexity for the forward and backward pass of our algorithm is O(rsd+d²), where r is the batch size, s is the average degree of nodes, and d is the attribute dimension. The process of random walk generation is fast and can be done in memory, which is abundantly available and highly parallelizable. Therefore, storing the graph structure in memory for sampling of positives doesn't create a memory bottleneck and takes O(m) space. For all the datasets other than ogbn-papers 100M, we store the AX, SX, and I in the GPU memory as well, requiring additional O(nd) space. However, for very large-scale datasets, one can conveniently store these in the memory itself and interface with the GPU when required, thereby restricting the GPU memory requirement to O(rsd+d²).

FIG. 9 depicts results on experiments using dataset generated from Stochastic Block Models. SC represents Spectral Clustering on the graph, k-means utilises only the attributes, Node2vec uses the graph structure and DGI utilizes both. We experiment with two variants of our method S³GC-I using only I as the learnable embeddings without using the attributes and S³GC using both graph and attributes, and evaluate the quality of clustering using mean NMI, reported over 3 runs.

Time Complexity: The forward and backward computation for a given batch takes O(rsd²) time. Hence, for n nodes, batch size of r, and K epochs, time complexity is O(Knsd²).

### Section 3.5 Synthetic Dataset—Stochastic Block Model with Gaussian Features

To better understand the working of our method in scenarios with varied quality of the graph structure and node attributes, we propose a study on a synthetic dataset using Stochastic Block Models (SBM) with Gaussian features. For a given parameter k, the SBM constructs a graph G=(V,E) with k partitions of nodes V. The probability of an intra-cluster edge is p and an inter-cluster edge is q, where p>q. Similar studies have been proposed for benchmarking of GNNs and Graph clustering methods using SBM. In this work, we create an attributed SBM model, where each node has an s-dimensional attribute associated with it. Following the setup in, for k clusters (partitions) we generate k cluster centers using s-multivariate normal distributions N(0ₛ, σ²_{c}·Iₛ), where σ²_{c} is a hyperparameter we define. Then attributes of nodes of a given cluster are sampled from an s-multivariate gaussian distribution with the corresponding cluster center and σ2I variance. The ratio σ²_{c}/σ² controls the expected value of the classical between vs within sum-of-squares of the clusters.

We compare our method with: k-means on the attributes, Spectral Clustering, DGI, and Node2vec. This choice of baseline methods focuses on different facets of graph data and clustering across which we want to assess the performance of our method. k-means on attributes utilizes only the nodes attribute information. Spectral Clustering is a non-trainable classical algorithm commonly used for solving SBMs, but uses only the graph-structure information. Similarly, Node2vec is a common graph-embedding trainable algorithm that utilizes only the structural information. DGI is a scalable SOTA self-supervised graph representation learning algorithm that uses both structure as well as node attributes.

To demonstrate the effectiveness of our choice of loss formulation, we also run our method without using any attribute information and using only the learnable embedding I□R^{n×d}, i.e. X=I.

Setup and Observations: We set the number of nodes n=1000 and number of clusters k=10, where each cluster contains n/k=100 nodes, and vary p and q to generate graphs of different structural qualities. Varying σ²_{c}/σ² controls the quality of the attributes. The first row in FIG. 9 represents a graph with high structural as well as attribute quality. The second row represents low structural as well as low attribute quality. While the last row represents low structural but high attribute quality. We make several observations: 1) Even without using any attribute information, our method performs significantly better as compared to other structure-only based methods like Spectral Clustering and Node2Vec, which demonstrates the effectiveness of our loss formulation and training methodology that promotes clusterability, which is also in line with recent observations. 2) We observe that DGI depends highly on the quality of the attributes and is not able to utilize the high-quality graph structure as well, when the attributes are noisy. In contrast, our method uses both sources of information effectively and performs reasonably well even when even only one of the structure or attribute quality is high (first and the last row in the table depicted in FIG. 9).

Visualization of the Embeddings: We further observe the quality of the generated embeddings using t-SNE projected in 2-dimensions. FIG. 7 corresponds to the second setting with weak graph and weak attributes, where we observe that S³GC generates representations which are more cluster-like as compared to the other methods. Additionally, we note that S³GC shows similar behaviour in the other two settings as well, the plots for which are provided below.

### Section 4 Empirical Evaluation

We conduct extensive experiments on several node classification benchmark datasets to evaluate the performance of S³GC as compared to key state-of-the-art (SOTA) baselines across multiple facets associated with Graph Clustering.

### Section 4.1 Datasets and Setup

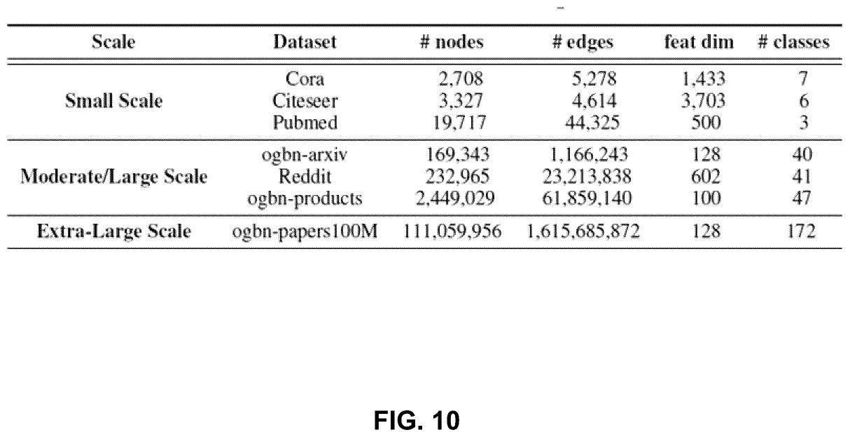

Datasets: We use 3 small scale, 3 moderate/large scale, and 1 extra large scale dataset from GCN, GraphSAGE and the OGB-suite to demonstrate the efficacy of our method. The details of the datasets are given in FIG. 10 and additional details of the sources are mentioned below.

Baselines: We compare our method with k-means on features and 8 recent state-of-the-art baseline algorithms, including MinCutPool, METIS, Node2vec, DGI, DMoN, GRACE, BGRL and MVGRL. We choose baseline methods from a broad spectrum of methodologies, namely methods that utilize only the graph structure, methods that utilize only the features and specific methods that utilize a combination of the graph structure and attribute information to provide an exhaustive comparison across important facets of graph learning and clustering. METIS is a well-known and scalable classical method for graph partitioning using only the structural information. Similarly, Node2vec is another scalable graph embedding technique that utilizes random walks on the graph structure. MinCutPool and DMON are graph clustering techniques motivated by the normalized MinCut objective and Modularity respectively. DGI is a SOTA self-supervised method utilizing both graph structure and features, that motivated a line of work based on entropy maximization between local and global views of a graph. GRACE, in contrast to DGI's methodology, contrasts embeddings at the node level itself, by forming two views of the graph and maximizing the embedding of the same nodes in the two views. BGRL and MVGRL are recent SOTA methods for performing self-supervised graph representation learning.

Metrics: We measure 5 metrics which are relevant for evaluating the quality of the cluster assignments following the evaluation setup of: Accuracy, Normalized Mutual Information (NMI), Completeness Score (CS), Macro-F1 Score (F1), and Adjusted Rand Index (ARI). For all these aforementioned metrics, a higher value indicates better clustering performance. We generate the representations using each representation-learning method and then perform k-means clustering on the embeddings to generate the cluster assignments used for evaluation of these metrics.

Detailed Setup. We consider the unsupervised learning setting for all the seven datasets where the graph and features corresponding to all the datasets are available. We use the labels only for evaluating the quality of the cluster assignments generated by each method. For the baselines, we use the official implementations provided by the authors without any modifications. All experiments are repeated 3 times and the mean values are reported in the FIG. 11a. We highlight the highest value as well as any other values within 1 standard deviation of the mean of the best performing method, and report the results with standard deviations as described below, due to space constraints. We utilize a single Nvidia A100 GPU with 40 GB memory for training each method for a maximum duration of 1 hour for each experiment in FIG. 11a. For ogbn-papers 100M we allow up to 24 hours of training and up to 300 GB main memory in addition. We provide a mini-batched and highly scalable implementation of our method S³GC in PyTorch such that experiments on all datasets other than ogbn-papers 100M easily fit in the aforementioned GPU. For the ogbn-papers 100M dataset, the forward and backward pass in S³GC are performed in the GPU, with an interfacing with the CPU memory to store the graph, AX, and SX, and to maintain and update I, with minimal overheads. We also provide a comparison of the time and space complexity for each method below.

Hyperparameter Tuning: S³GC requires selection of minimal hyperparameters: we use k=2 for the k-hop Diffusion Matrix Sₖ which offers the following advantages: 1) S₂X=α₀X+αAX+α₂A²X is a finite computation which can be pre-computed and only requires 2 sparse-dense matrix multiplications. 2) We chose α₀>α₁>α₂, giving a higher weight to 0-hop neighbourhood attributes X which allows S³GC to exploit the rich information from good quality attributes even when the structural information is not very informative. 3) Two-hop neighborhood intuitively captures all the features of nodes with similar attributes while maintaining scalability. This is motivated by the 2-hop and 3-hop choice of neighborhoods in and for these datasets. We additionally tune the learning rate, batch size and random walk parameters, namely the walk length 1 while using the default values of p=1 and q=1 for the bias parameters in the walk. We perform model selection based on the NMI on the validation set and evaluate all the metrics for this model. Additional details regarding the hyperparameters are mentioned below.

### Section 4.2 Results

FIG. 11a compares clustering performance of S³GC to a number of baseline methods on datasets of three different scales. For the small scale datasets, namely Cora, Citeseer and Pubmed, we observe that MVGRL outperforms all methods. We also note that MVGRL's performance in our experiments, using the author's official implementation with extensive hyperparameter tuning is slightly lower than the reported values, as has been reported by other works as well. Nonetheless, we use these values for comparison and observe that S³GC also performs either competitively or is slightly inferior to MVGRL's accuracy. For example, on the Cora dataset, S³GC is within 2% of MVGRL's performance and outperforms all the other baseline methods, while on the Pubmed dataset, S³GC is within □1.5% of MVGRL's performance. Next, we observe the performance on moderate/large scale datasets and note that S³GC significantly outperforms baselines such as k-means, MinCutPool, METIS, Node2vec, DGI and DMON. Notably, S³GC is □5% better on ogbn-arxiv, □1.5% better on Reddit and □4% better on ogbn-products in terms of clustering NMI as compared to the next best method. The official implementations of GRACE, BGRL, and MVGRL do not scale to datasets with >200 k nodes, running into Out of Memory (OOM) errors due to the non-scalable implementations, sub-optimal memory utilization, or the non-scalable methodology. For example, MVGRL proposes diffusion matrix as the alternate view of graph structure, which is a dense n×n matrix—hence, not scalable.

We also note that S³GC performs reasonably well in settings where the node attributes are not very informative while the graph structure is useful, as evident from the performance on the Reddit dataset. k-means on the node attributes gives an NMI of only 10% while methods like METIS and Node2vec perform well using the graph structure. Methods like DGI which depend heavily on the quality of the attributes, thus suffer a degradation in performance having a clustering NMI of only □30% while S³GC which uses both the attributes and graph information effectively outperforms all the other methods and generates clustering with an NMI of □80%

ogbn-papers 100M: Finally, we compare the performance of S³GC on the extra-large scale dataset with 111M nodes and 1.6B edges in FIG. 11b, and note that only k-means, Node2vec and DGI scale to this dataset size and run in a reasonable time of □24 hours. We observe that S³GC seamlessly scales to this dataset and significantly outperforms methods utilizing only the features (k-means) by □8.5% only graph structure (Node2vec) by □7% and both (DGI) by □4% in terms of clustering NMI on the ogbn-papers 100M dataset.

FIG. 11a: Comparison of clustering obtained by our method S³GC to several state-of-the-art methods. Metrics for evaluation across different datasets and experiments are Accuracy, NMI, CS, F1 and ARI as described in Section 4. We use the official implementations provided by the authors for all the methods and provide additional details below. * denotes that the method ran Out of Memory (OOM) while trying to run the experiments on the hardware as specified in Section 4. ∥ indicates that the method did not converge.

FIG. 11b: Results of comparison of the embeddings generated by our method S3GC as compared to different scalable methods on ogbn-papers 100M with 111M nodes and 1.6B edges.

Ablation Study on Hyperparameters: We perform detailed ablation studies to investigate the stability of S³GC's clustering and provide the same, as described below. We find that S³GC is robust to its few hyperparameters such as walk-length and batch size, enabling a near-optimal choice. We note that smaller walk lengths □5 are an optimal choice across datasets, since they are able to include the “right” positive examples in the batch, while using larger walk lengths may degrade the performance due to the inclusion of nodes belonging to other classes in the positive samples. This helps in scalability as well, as we need to sample only a few positives per node. While small batches take more time per-epoch but converge faster, larger batch sizes are better in per-epoch training time, but require more epochs to converge. Both, however, enjoy similar performance in terms of the quality of the clustering.

### Section 5 Discussion and Future Work

We introduced S³GC, a new method for scalable graph clustering with node feature side-information. S³GC is a simple method based on contrastive learning along with a careful encoding of graph and node features, but it is an effective approach across all scales of data. In particular, we showed that S³GC is able to scale to graphs with 100M nodes while still ensuring SOTA clustering performance.

Limitations and FutureWork: S³GC demonstrates empirically that on Stochastic Block Models along with mixture-of-Gaussian features, it is able to identify the clusters accurately. Further theoretical investigation into this standard setting and establishing error bounds for S³GC is of interest. S³GC can be applied to graphs with heterogeneous nodes, but it cannot explicitly exploit the information. Extension of S³GC to cluster graphs while directly exploiting heterogeneity of nodes is another open problem. Finally, S³GC like all deep learning methods is susceptible to being unfairly biased by a few “important” nodes. Ensuring stable clustering techniques with minimal bias for a small number of nodes is another interesting direction.

Section A. Overview of the method.

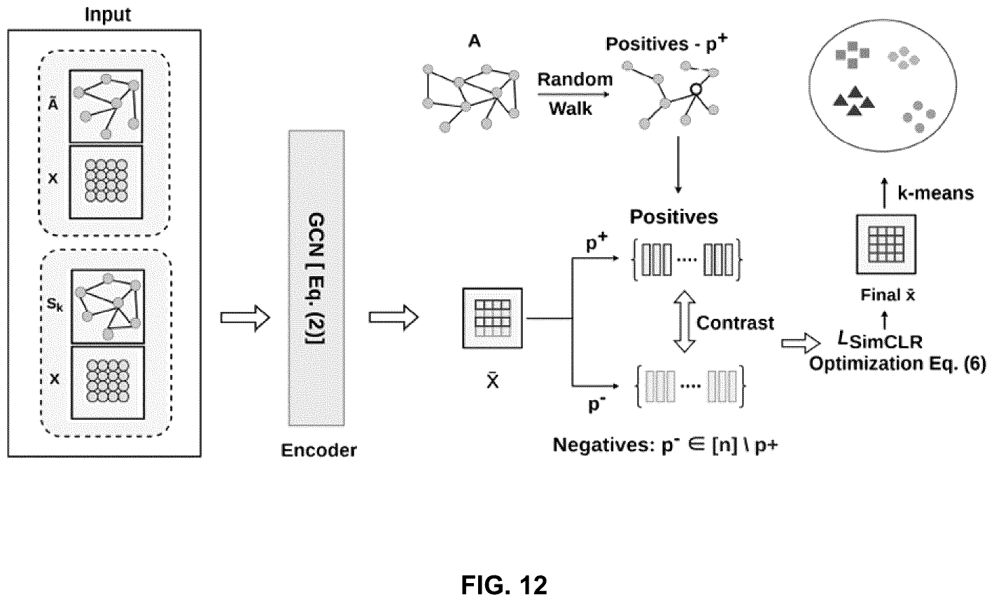

FIG. 12 provides an overview of the proposed method S³GC.

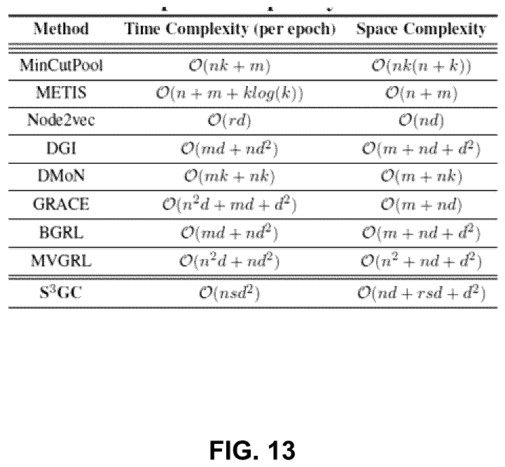

Time and Memory Overheads for Various Methods. In FIG. 13, we compare the time and space complexities of all the methods used in FIG. 11, and observe that S³GC performs better in terms of both time and memory complexity as compared to the other self-supervised learning methods that utilise both graph and feature information. Recall that n is the number of nodes in the graph, m is the number of edges, d is the dimensionality of features, r is the batch size, k is the number of classes, and s is the average degree per node.

For DGI, GRACE, and BGRL, the mentioned complexities are using full batch training. We use batched training on large datasets for DGI using GraphSAGE which reduces time complexity to O(nfd²) and space complexity to O(rfd+d²), which is competitive with our method. Here, f is the number of sampled neighbours in GraphSAGE per node.

FIG. 13: Time and Space Complexity of different methods.

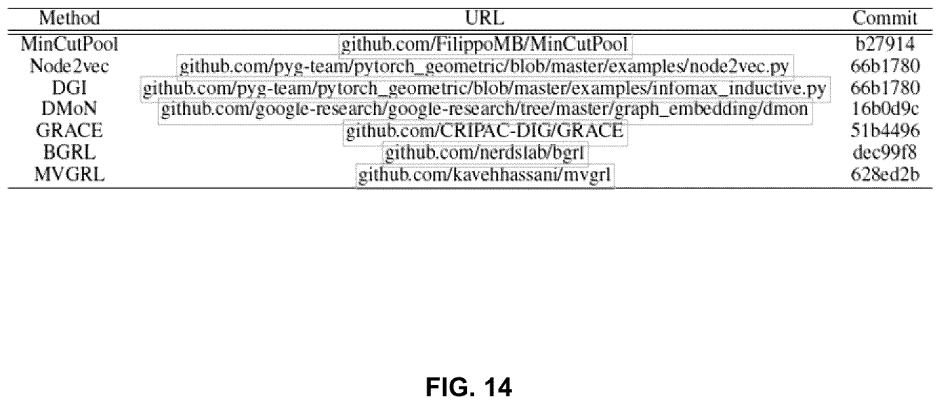

Hyperparameter Configurations for our method and the baselines We use the k-means implementation from sklearn3, METIS 5.1.0 from the official source4 and Node2vec and DGI implementations from PyTorch geometric5. The sources for all the relevant baselines and their implementations are mentioned in FIG. 14.

FIG. 14: URL's and commit numbers to run baseline codes

We use the Adam optimizer for S³GC and fix the embedding dimension to be the same across methods for a fair comparison, namely we set the embedding dimension d to be 256 for all the methods for all datasets, except ogbn-papers 100M where we use an embedding dimension d=64 due to memory and scalability constraints. For all the methods we set the number of clusters equal to the number of classes. For trainable methods, a grid search was performed over hyperparameters specific to each method which is summarized below, while the other parameters are set to the default values:
1. MinCutPool: Learning Rate—{0.005, 0.001, 0.0005, 0.0001}, Num of Clusters=# of classes
2. Node2vec: Learning Rate—{0.01, 0.001}, Walk length—{10, 20, 40, 80}, Context Size—{5, 10, 20, 40}
3. DGI: Learning Rate—{0.005, 0.001, 0.0005, 0.0001}, 3-hop Neighborhood sampling size (for large datasets)—{{15, 10, 5}, {25, 20, 10}}
4. DMON: Learning Rate—{0.01, 0.005, 0.001, 0.0005, 0.0001}, Dropout—{0.0, 0.1, 0.2, 0.3, 0.4, 0.5}
5. GRACE: all hyperparameters as default provided by the authors for each dataset
6. BGRL: Learning Rate—{0.0005, 0.0001, 0.00005, 0.00001 }, Dropout—{0.0, 0.1, 0.2, 0.3, 0.4, 0.5, 0.6}
7. MVGRL: Learning Rate—{0.005, 0.001, 0.0005, 0.0001}
8. S³GC: Learning Rate—{0.01, 0.001 }, Batch Size—{256, 512, 2048, 4096, 10000, 20000}, Walk Length—{3, 5, 10, 20, 50}, Number of walks per node—{10, 15, 20}

### Section C Dataset Statistics and Additional Experimental Results

### C.1 Datasets

We use 7 datasets of three different scales of sizes, the statistics for which are provided in FIG. 10. We provide more information regarding the source and nature of the datasets as follows:
1. Cora, Citeseer and Pubmed6: These are three citation network datasets consisting of sparse bag-of-words feature vectors for each document. The edges denote citation links between the documents and are treated as undirected edges following the setup in. Each node has a label class associated with the document.
2. ogbn-arxiv7: It is a citation dataset from the OGB node property prediction suite representing the network of Computer Science ARXIV papers as indexed by MAG, where each node is a paper and each edge indicates a citation. Each node has an associated label which is one of the subject area from the 40 subject areas in ARXIV Computer Science papers. Feature vectors of the nodes are obtained from an average of word2vec embeddings of the title and abstract.
3. Reddit8: The dataset is constructed from Reddit posts made in month of September 2014, with each node representing a post and node labels representing the community that the post belonged to. Nodes are connected based on common users commenting on both the posts, and node features are averaged 300-dimensional GloVe word vectors of the content associated with the posts such as title, comments, score and number of comments. More information regarding the setup can be found in Hamilton et. al.
4. ogbn-products9: It is an Amazon co-purchasing network dataset where nodes represent Amazon products and edges indicate that the two products are purchased together. Each node has an associated label which denotes the category of the product. Node features are dimensionality reduced bag of words features of the product descriptions, following the setup in OGB.
5. ogbn-papers 100M10: It is a very large scale citation network dataset consisting of 111 million papers indexed by MAG. Node features and graph structure for this dataset is created in the same way as done for the ogbn-arxiv dataset in OGB, while labels are one of the 172 subject areas of a subset of papers published on ARXIV.

### Section C.2 Visualisation of Embeddings for Synthetic Data Experiment

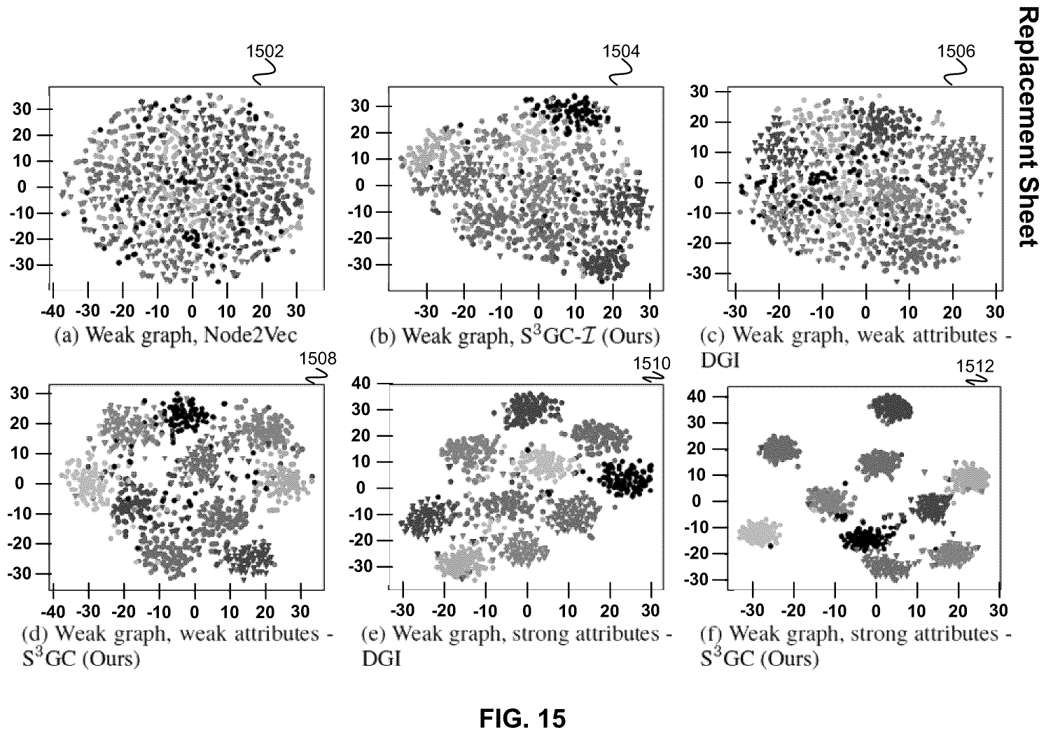

To understand the performance of S³GC as compared to the other methods in learning representations on Synthetic datasets, we observe the quality of the generated embeddings using t-SNE projected in 2-dimensions for the setup discussed in FIG. 9 and Section 3.5. We note that the first row refers to a high quality graph with strong attributes, the second row refers to a weak graph with weak attributes, and the third row refers to a weak graph with strong attributes. We note that all methods perform similarly in the first setting when both the graph and attributes are of good quality, however show varied performance when either or both of them are varied in quality. Hence, FIG. 15 visualizes the performance of Node2vec, DGI and S³GC in the second and the third settings. We observe from graph 1502 that Node2vec doesn't learn much distinguishable representations when the quality of the graph is weak, which can be attributed to Node2vec being dependent only on the graph structure for learning embeddings. Note that we also perform an experiment with S³GC using only the weak graph information (without using any attributes), denoted by S³GC-I and visualized in graph 1504.

We observe that S³GC-I learns more “cluster-like” representations as compared to Node2vec even when utilizing only the weak quality graph information, indicating that the loss formulation in S³GC promotes learning clusterable representations. Then, we compare the performance of DGI and S³GC in the second and third settings, and visualize the learnt representations in graphs 1506, 1508, 1510, and 1512 We observe that S³GC learns representations that correspond to more well-defined clusters as compared to DGI in each of the settings, indicating that S³GC is able to use both the graph and attribute information more efficiently, even in settings with varied data quality.

FIG. 15 is a visualization of embeddings.

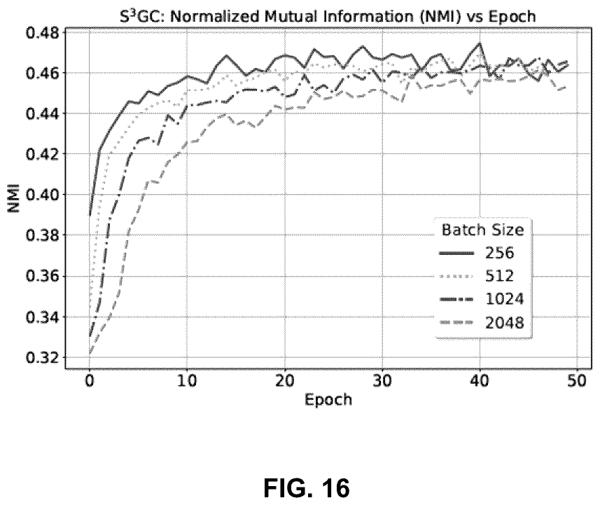

FIG. 16 is an ablation study on the effect of using different batch sizes in S³GC on the ogbn-arxiv dataset.

To understand the effect of varying the batch size in S³GC, we perform an ablation study on the ogbn-arxiv dataset by keeping the other parameters such as learning rate and walk length constant, while varying the batch size. We train S³GC for different batch sizes from {256, 512, 1024, 2048} and report the clustering NMI vs Epoch performance corresponding to each configuration in FIG. 16.

We observe that smaller batch sizes show faster convergence, and hence require lesser epochs to reach a reasonably good clustering performance in terms of NMI after which the performance saturates. Larger batches require more epochs however also require lesser per-epoch time as compared to smaller batches. We do note that the final performance corresponding to the different batch sizes are very similar.

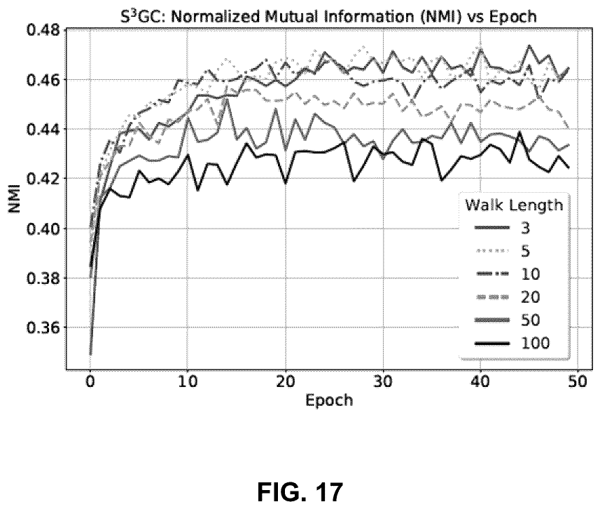

FIG. 17: Ablation study on the effect of using different walk lengths in S³GC on the ogbn-arxiv dataset.

### C.4 Ablation on Walk Length

To understand the effect of varying the length of random walks in S³GC for the sampling of positives, we perform an ablation study on the ogbn-arxiv dataset by keeping the other parameters such as learning rate and batch size constant, while varying the walk length. We train S³GC for different walk lengths from {3, 5, 10, 20, 50, 100} and report the clustering NMI vs Epoch performance corresponding to each configuration in FIG. 5. We observe that smaller walk lengths up to □5 show best performance in terms of the clustering NMI, after which the performance starts to degrade with larger walk lengths. This can be attributed to the inclusion of unrelated or “farther-away” nodes belonging to different classes as positives in the batch. We also observe that the walk length parameter □5 is optimal across datasets and hence does not require significant hyperparameter tuning.

### Section C.5 Main Table Results with Mean and Standard Deviation Values

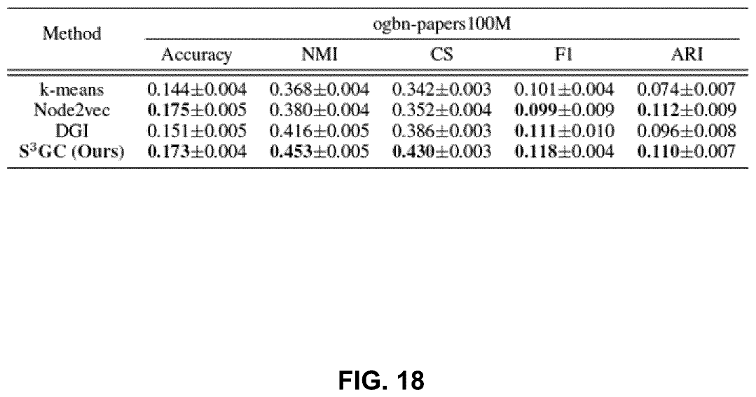

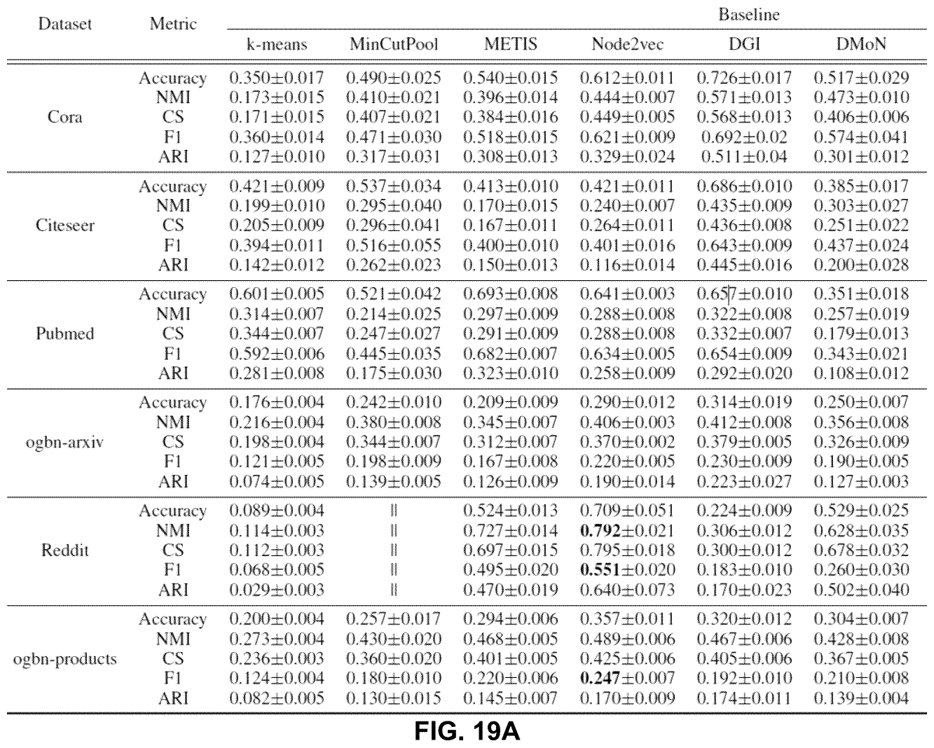

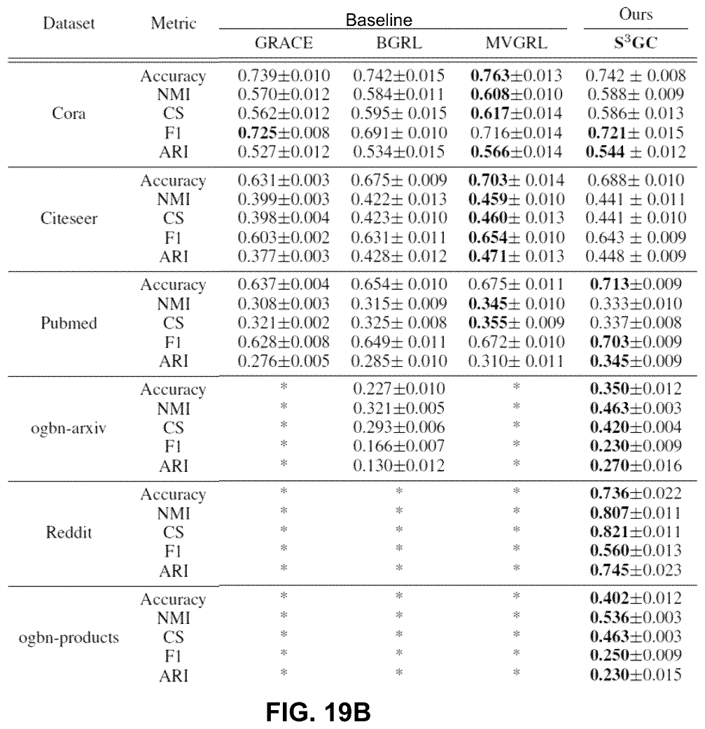

We provide detailed results for all the methods with mean and standard deviation values in the evaluation of all the metrics across datasets, in FIGS. 18 and 19 respectively. We observe similar results as discussed in the main paper.

FIG. 18: Results of comparison of the embeddings generated by our method S³GC as compared to different scalable methods on ogbn-papers 100M with 111M nodes and 1.6B edges, with mean and std values.

FIG. 19 is a comparison of clustering obtained by our method S³GC to several state-of-the-art methods, with mean and std values. Metrics for evaluation across different datasets and experiments are Accuracy, NMI, CS, F1 and ARI as described in Section 4. We use the official implementations provided by the authors for all the methods and as mentioned in the above. * denotes that the method ran Out of Memory (OOM) while trying to run the experiments on the hardware as specified in Section 4. ∥ indicates that the method did not converge.

### VI. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method of training a machine learning model, the method comprising:
receiving training data for the machine learning model, wherein the training data comprises a graph structure and one or more feature attributes;
determining an encoded graph based on applying the machine learning model to the graph structure and the one or more feature attributes, wherein the machine learning model comprises a graph convolutional network layer, wherein the encoded graph comprises one or more nodes and one or more paths connecting the one or more nodes;
selecting a plurality of positive samples through random walks along the one or more paths of the encoded graph;
selecting a plurality of negative samples from the encoded graph by randomly sampling the one or more nodes of the encoded graph;
determining, based on applying a contrastive loss function to the plurality of positive samples and to the plurality of negative samples, a loss value; and
updating, based on the loss value, one or more learnable parameter values of the graph convolutional network layer of the machine learning model.

2. The method of claim 1, wherein the machine learning model consists of a single layer, wherein the single layer is the graph convolutional network layer.

3. The method of claim 1, wherein the machine learning model further comprises a parametric rectified linear unit activation function.

4. The method of claim 1, wherein the machine learning model further comprises a L2 normalization function.

5. The method of claim 1, wherein the method of training the machine learning model is self-supervised.

6. The method of claim 1, wherein a quantity of the one or more learnable parameter values is based on a dimension of the one or more feature attributes.

7. The method of claim 1, wherein the method of training the machine learning model uses a quantity of memory based on a batch size, an average degree of nodes, and a dimension of the one or more feature attributes.

5. The method of claim 1, wherein the training data comprises a plurality of mini-batches, wherein determining the encoded graph comprises applying the machine learning model to a mini-batch of the plurality of mini-batches.

6. The method of claim 1, wherein the graph structure comprises a plurality of nodes and a plurality of paths each connecting a node of the plurality of nodes to another node of the plurality of nodes.

7. The method of claim 1, wherein determining the encoded graph based on applying the machine learning model to the graph structure and the one or more feature attributes comprises:
determining, based on graph structure and the one or more feature attributes, a normalized adjacency matrix and a k-hop diffusion matrix;
applying the machine learning model to the normalized adjacency matrix and the k-hop diffusion matrix to obtain an encoded normalized adjacency matrix and an encoded k-hop diffusion matrix; and
determining the encoded graph by normalizing a sum of the encoded normalized adjacency matrix, the encoded k-hop diffusion matrix, and a learnable matrix.

8. The method of claim 1, wherein a time complexity of training the machine learning model varies linearly based on the number of nodes.

9. The method of claim 1, wherein the training data comprises a plurality of mini-batches of a predetermined size, wherein determining the encoded graph comprises applying the machine learning model to a mini-batch of the plurality of mini-batches, wherein a time complexity of training the machine learning model varies linearly based on the predetermined size.

10. The method of claim 1, wherein selecting the plurality of positive samples through random walks along the one or more paths of the encoded graph comprises using a biased second order random walk through the encoded graph to obtain the plurality of positive samples.

11. The method of claim 1, wherein the random walk starts at a particular node, wherein selecting the plurality of positive samples through random walks along the one or more paths of the encoded graph comprises determining one or more similar nodes of the encoded graph that are similar to the particular node at which the random walk starts.

12. The method of claim 1, wherein the method further comprises:
determining a node set by taking a union of the plurality of positive samples and the plurality of negative samples.

13. The method of claim 1, wherein applying a contrastive loss function to the plurality of positive samples and to the plurality of negative samples results in a linearly separable representation.

14. The method of claim 1, wherein the method is carried out by a single virtual machine.

15. A method of applying a machine learning model, the method comprising:
determining an encoded graph output by applying a trained machine learning model to a graph structure input and one or more feature attribute inputs, wherein the trained machine learning model comprises a graph convolutional network layer, wherein the machine learning model outputs an encoded graph based on one or more learnable parameter values of the graph convolutional network layer, wherein the one or more learnable parameter values of a graph convolutional network layer of the trained machine learning model were determined by applying a contrastive loss function to a plurality of positive samples selected through random walks along one or more paths of an encoded graph and a plurality of negative samples selected from the encoded graph by randomly sampling one or more nodes of the encoded graph; and
applying a clustering algorithm to the encoded graph output to determine one or more graph clusters, wherein each graph cluster comprises one or more nearby nodes of the graph structure input with similar feature attributes.

16. The method of claim 15, wherein the clustering algorithm is a k-means clustering algorithm.

17. The method of claim 15, wherein applying a clustering algorithm to the encoded graph output to determine the one or more graph clusters comprises determining a finite number of graph clusters.

18. The method of claim 15, wherein the encoded graph output comprises one or more vector embeddings, wherein each of the one or more vector embeddings corresponds to a node of the graph structure input.

19. The method of claim 15, wherein determining an encoded graph output by applying a trained machine learning model to a graph structure input and one or more feature attribute inputs comprises:
determining, based on graph structure input and the one or more feature attribute inputs, a normalized adjacency matrix and a k-hop diffusion matrix;
applying the machine learning model to the normalized adjacency matrix and the k-hop diffusion matrix to obtain an encoded normalized adjacency matrix and an encoded k-hop diffusion matrix; and
determining the encoded graph by adding the encoded normalized adjacency matrix, the encoded k-hop diffusion matrix, and a learnable matrix.

20. A system comprising:
a processor; and
a non-transitory computer-readable medium having stored thereon instructions that, when executed by the processor, cause the processor to perform operations in accordance with any of claims 1-19.

21. A non-transitory computer-readable medium having stored thereon instructions that, when executed by a computing device, cause the computing device to perform operations in accordance with any of claims 1-19.
